(19) United States
(12) Patent Application Publication
(10) Pub. No.: US 2026/0005957 A1
(43) Pub. Date: Jan. 1, 2026

(54) SEGMENT ROUTING (SR) BINDING PROTECTION

(71) Applicant: HUAWEI TECHNOLOGIES CO., LTD., Shenzhen (CN)

(72) Inventor: Huaimo Chen, Bolton, MA (US)

(73) Assignee: HUAWEI TECHNOLOGIES CO., LTD., Shenzhen (CN)

(21) Appl. No.: 19/317,081

(22) Filed: Sep. 2, 2025

Related U.S. Application Data
(63) Continuation of application No. PCT/US2024/012620, filed on Jan. 23, 2024.
(60) Provisional application No. 63/487,733, filed on Mar. 1, 2023.

(51) Int. Cl. H04L 45/28; H04L 45/122; H04L 45/655

(52) U.S. Cl. CPC H04L 45/28; H04L 45/122; H04L 45/655

(57) ABSTRACT

A method for providing segment routing (SR) binding protection. The method includes determining binding information of a binding node on an SR path and transmitting binding protection information to one or more nodes to support routing of a packet of the SR path when the binding node fails.

### CROSS-REFERENCE TO RELATED APPLICATIONS

This application is a continuation of International Application No. PCT/US2024/012620, filed on Jan. 23, 2024, which claims the benefit of U.S. provisional patent application No. 63/487,733 filed Mar. 1, 2023 and titled “SR Binding Protection”. The disclosures of the aforementioned applications are hereby incorporated by reference in their entireties.

### TECHNICAL FIELD

This application relates to network communication, and more specifically to segment routing (SR) binding protection.

### BACKGROUND

Segment Routing Traffic Engineering (SR-TE) is a technology that enables explicit paths to be specified for routing a packet. In particular, segment routing (SR) uses a segment list to steer a packet through a specific set of nodes and links in an SR domain along an SR-TE path or SR path. An SR domain is a collection of nodes (e.g., routers) that are configured to perform SR within a domain. Each node and link/adjacency in an SR is allocated a label or an Internet Protocol Version 6 (IPv6) address that is used as a segment identifier (SID) of the node and link/adjacency. The label is called SR-Multi-Protocol Label Switching (SR-MPLS) SID, and the IPv6 address is called SR version 6 (SRv6) SID. To steer packets through the specified set of nodes and links, an ingress router of the domain prepends a segment list (i.e., an order list specifying one or more segments) to a packet to specify for routing the packet. This enables the packet to be routed through an explicit path of the domain. For example, SR-TE may be used to guarantee a particular quality of service (QOS) for packets corresponding to a service-level agreement (SLA).

### SUMMARY

A first aspect relates to a method implemented by a controller. The method includes determining binding information of a binding node on a segment routing (SR) path; determining binding protection information based on the binding information; and transmitting the binding protection information, the binding protection information supports routing of a packet when the binding node fails.

Optionally, in a first implementation according to the first aspect, the method further includes exchanging capability information with nodes on the SR path, the capability information indicating whether the nodes support binding and/or adjacency protection.

Optionally, in a second implementation according to the first aspect or any implementation thereof, exchanging capability information includes exchanging a Path Computation Element (PCE) Communication Protocol (PCEP) OPEN message that includes a PATH SETUP_TYPE_CAPABILITY Type-Length-Value (TLV), the PATH SETUP_TYPE CAPABILITY TLV includes a Path Setup Type (PST) and a BINDING ADJACENCY PROTECTION (BAP) CAPABILITY sub-TLV, and the PST includes a value indicating a capability of binding and/or adjacency protection.

Optionally, in a third implementation according to the first aspect or any implementation thereof, exchanging capability information includes exchanging a PCEP OPEN message that includes a PATH SETUP_TYPE CAPABILITY TLV, the PATH_SETUP_TYPE_CAPABILITY TLV includes a Central Controller (PCECC)-CAPABILITY sub-TLV, and the PCECC-CAPABILITY Sub-TLV includes a B flag field set to a first value indicating a first capability of binding protection and an A flag field set to a second value indicating a second capability of adjacency protection.

Optionally, in a fourth implementation according to the first aspect or any implementation thereof, the method further includes determining that the SR path is within a domain, and transmitting the binding protection information includes: transmitting a second binding protection information part to an upstream neighbor node of the binding node on the SR path, the second binding protection information part includes a binding segment identifier (BSID) of the binding node (BSID-B), a backup SID list, and an identifier (ID) of the binding node (ID-B).

Optionally, in a fifth implementation according to the first aspect or any implementation thereof, the second binding protection information part further includes an instruction, the instruction instructs the upstream neighbor node to use the second binding protection information part when the binding node on the SR path fails.

Optionally, in a sixth implementation according to the first aspect or any implementation thereof, the method further includes transmitting second binding protection information part to a closest upstream endpoint node of the binding node on the SR path when the binding node is a loose hop on the SR path and the closest upstream endpoint node is not a neighbor node of the binding node.

Optionally, in a seventh implementation according to the first aspect or any implementation thereof, the method further includes determining that the SR path crosses from a first domain to a second domain.

Optionally, in an eighth implementation according to the first aspect or any implementation thereof, the method further includes determining that one provider operates the first domain and the second domain, and transmitting the binding protection information includes: transmitting a second binding protection information part to an upstream neighbor node of the binding node on the SR path, the second binding protection information part includes a BSID of the binding node (BSID-B), a backup SID list, and an ID of the binding node (ID-B); and transmitting the second binding protection information part to a closest upstream endpoint node of the binding node on the SR path when the binding node is a loose hop on the SR path and the closest upstream endpoint node is not a neighbor node of the binding node.

Optionally, in a ninth implementation according to the first aspect or any implementation thereof, the method further includes determining an adjacency segment identifier (SID) of a node in the SR path used for crossing the first domain and the second domain or the next hop of the node is in the second domain; and transmitting adjacency protection information to an upstream neighbor node of the node, the adjacency protection information supports routing of the packet when the node fails.

Optionally, in a tenth implementation according to the first aspect or any implementation thereof, the method further includes transmitting the adjacency protection information a closest upstream endpoint node of the node when the node is a loose hop on the SR path and the closest upstream endpoint node is not a neighbor node of the node.

Optionally, in an eleventh implementation according to the first aspect or any implementation thereof, the method further includes determining that a first provider operates the first domain and a second provider operates the second domain, and transmitting the binding protection information includes: transmitting a first binding protection information part to an alternate binding node, the first binding protection information part includes a BSID of the alternate binding node (BSID-aB) and a corresponding SID list, the corresponding SID list is obtained from a binding SID list of the binding node based on a first SID in the binding SID list; transmitting a second binding protection information part to an upstream neighbor node of the binding node on the SR path, the second binding protection information part includes a BSID of the binding node (BSID-B), a backup SID list, and an ID of the binding node (ID-B); and transmitting the second binding protection information part to a closest upstream endpoint node of the binding node on the SR path when the binding node is a loose hop on the SR path and the closest upstream endpoint node is not a neighbor node of the binding node.

Optionally, in a twelfth implementation according to the first aspect or any implementation thereof, the corresponding SID list is the same as the binding SID list when the first SID in the binding SID list is a node SID, and the corresponding SID list is obtained by replacing the first SID in the binding SID list with a node SID of a remote node when the first SID in the binding SID list is an adjacency SID to the remote node.

Optionally, in a thirteenth implementation according to the first aspect or any implementation thereof, the binding information includes an ID of the binding node, a BSID of the binding node, and a binding SID list associated with the BSID.

A second aspect relates to a method implemented by a node. The method includes receiving binding protection information for a binding node on a segment routing (SR) path, the binding protection information supports routing of a packet when the binding node fails; create a first forwarding information base (FIB) entry based on the binding protection information; receiving a packet; and execute a first instruction according to the first FIB entry for routing the packet when the binding node fails.

Optionally, in a first implementation according to the second aspect, the method further includes exchanging capability information with a controller, the capability information indicating whether the node supports binding and/or adjacency protection.

Optionally, in a second implementation according to the second aspect or any implementation thereof, the binding protection information includes the instruction.

Optionally, in a third implementation according to the second aspect or any implementation thereof, the node is an upstream neighbor node of the binding node on the SR path, the binding protection information includes a second binding protection information part, and the second binding protection information part includes a binding segment identifier (BSID) of the binding node (BSID-B), a backup SID list, and an identifier (ID) of the binding node (ID-B).

Optionally, in a fourth implementation according to the second aspect or any implementation thereof, the node is a closest upstream endpoint node of the binding node on the SR path, the binding protection information includes a second binding protection information part, and the second binding protection information part includes a binding segment identifier (BSID) of the binding node (BSID-B), a backup SID list, and an identifier (ID) of the binding node (ID-B).

Optionally, in a fifth implementation according to the second aspect or any implementation thereof, the first instruction instructs the node to replace the BSID-B in a segment list of the packet with the backup SID list.

Optionally, in a sixth implementation according to the second aspect or any implementation thereof, the method further includes receiving adjacency protection information for an adjacency node on an SR path, the adjacency protection information supports routing of the packet when the adjacency node fails; create a second FIB entry based on the adjacency protection information; and execute a second instruction according to the second FIB entry for routing the packet when the adjacency node fails.

Optionally, in a seventh implementation according to the second aspect or any implementation thereof, the adjacency protection information includes an adjacency SID of the adjacency node (SID-B-R), a node SID of a remote node of the adjacency SID (SID-R), and an ID of the adjacency node (ID-B), and the second instruction instructs the node to replace the adjacency SID of the adjacency node (SID-B-R) in a segment list of the packet with the node SID of the remote node (SID-R) when the adjacency node fails.

Optionally, in an eight implementation according to the second aspect or any implementation thereof, the adjacency protection information includes an adjacency SID of the adjacency node (SID-B-R), a node SID of a remote node of the adjacency SID (SID-R), and an ID of the adjacency node (ID-B), and the second instruction instructs the node to replace the adjacency SID of the adjacency node (SID-B-R) in a segment list of the packet with the node SID of the remote node (SID-R) when the adjacency node fails.

Optionally, in a ninth implementation according to the second aspect, the method further includes transmitting the packet according to a third FIB entry of a top SID of the packet without going through the binding node when the binding node fails and/or through the adjacency node when the adjacency node fails and IGP has not converged.

Optionally, in a tenth implementation according to the second aspect, the method further includes transmitting the packet according to a third FIB entry of a top SID of the packet along a shortest path when the binding node fails and/or when the adjacency node fails and IGP has converged.

A third aspect relates to a network device that includes a memory configured to store instructions; and one or more processors coupled to the memory and configured to execute the instructions to cause the network device to perform a method according to the first aspect, the second aspect, or any implementation thereof.

A fourth aspect relates to a computer program product comprising computer-executable instructions stored on a non-transitory computer-readable storage medium, the computer-executable instructions when executed by a processor of an apparatus, cause the apparatus to perform a method according to the first aspect, the second aspect, or any implementation thereof.

For clarity, any one of the foregoing embodiments may be combined with any one or more of the other foregoing embodiments to create a new embodiment within the scope of the present disclosure.

These and other features, and the advantages thereof, will be more clearly understood from the following detailed description taken in conjunction with the accompanying drawings and claims.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a diagram illustrating an example of SR in a single domain.

FIG. 2 is a diagram illustrating a first example of SR across domains.

FIG. 3 is a diagram illustrating a second example of SR across domains.

FIG. 4 is a diagram illustrating a third example of SR across domains.

FIG. 5 is a flowchart illustrating a method implemented by a controller for providing SR binding protection according to an embodiment of the present disclosure.

FIG. 6 is a flowchart illustrating a method implemented by an upstream endpoint node of a binding node for providing SR binding protection according to an embodiment of the present disclosure.

FIG. 7 is a flowchart illustrating a method implemented by an upstream endpoint node of an adjacency node for providing SR binding protection according to an embodiment of the present disclosure.

FIG. 8 is a flowchart illustrating a method implemented by an upstream neighbor node of a binding node for providing SR binding protection according to an embodiment of the present disclosure.

FIG. 9 is a flowchart illustrating a method implemented by an upstream neighbor node of an adjacency node for providing SR binding protection according to an embodiment of the present disclosure.

FIG. 10 is a flowchart illustrating a method implemented by an alternate binding node for providing SR binding protection according to an embodiment of the present disclosure.

FIG. 11 is a diagram illustrating SR binding protection performed by an upstream endpoint node of a binding node in accordance with an embodiment.

FIG. 12 is a diagram illustrating SR binding protection performed by an upstream neighbor node of a binding node in accordance with an embodiment.

FIG. 13 is a diagram illustrating SR binding protection performed by an upstream neighbor node of a binding node in accordance with an embodiment.

FIG. 14 is a diagram illustrating SR adjacency protection performed by an upstream neighbor node of a binding node in accordance with an embodiment.

FIG. 15 illustrates a BINDING ADJACENCY PROTECTION (BAP) CAPABILITY sub-type length value (sub-TLV) according to an embodiment of the present disclosure.

FIG. 16 illustrates a PATH-SETUP-TYPE-CAPABILITY TLV according to an embodiment of the present disclosure.

FIG. 17 illustrates a PCECC-CAPABILITY sub-TLV according to an embodiment of the present disclosure.

FIG. 18 illustrates a PATH-SETUP-TYPE TLV according to an embodiment of the present disclosure.

FIG. 19 illustrates a binding segment identifier (BSID) TLV according to an embodiment of the present disclosure.

FIG. 20 illustrates an adjacency SID TLV according to an embodiment of the present disclosure.

FIG. 21 illustrates a node SID TLV according to an embodiment of the present disclosure.

FIG. 22 illustrates a SR version 6 (SRv6) SID with behavior and structure format according to an embodiment of the present disclosure.

FIG. 23 illustrates a SID-List TLV according to an embodiment of the present disclosure.

FIG. 24 illustrates a TE Router ID TLV according to an embodiment of the present disclosure.

FIG. 25 is a diagram illustrating a network device according to an embodiment of the present disclosure.

### DESCRIPTION OF EMBODIMENTS

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

SR-TE enables explicit paths (referred to herein as an SR-TE path, an SR path, or a path) to be specified for routing a packet by prepending a segment list to a packet. The segment list may contain different types of segment identifiers (SIDs) including adjacency SIDs, node SIDs, and binding SIDs (BSIDs). When a node on an SR path having a BSID specified in a segment list of a packet fails, the network may no longer be able to properly forward traffic on that SR path. Accordingly, the present disclosure describes various embodiments that provide SR binding protection when a node associated with a BSID specified in a segment list of a packet fails.

Additionally, the disclosed embodiments provide SR binding protection of a node on a SR path before interior gateway protocol (IGP) converges on the failure of the node and after IGP converges on the failure of the node. IGP is a protocol used to update link state information within a domain. Before IGP converges means that other nodes in the domain are not aware that the node has failed (e.g., the forwarding information base (FIB) table locally stored on the other nodes have not been updated and still include a FIB entry to the failed node). In contrast, after IGP converges means that other nodes in the domain are aware that the node has failed (e.g., local FIB table has been updated to remove FIB entry to failed node).

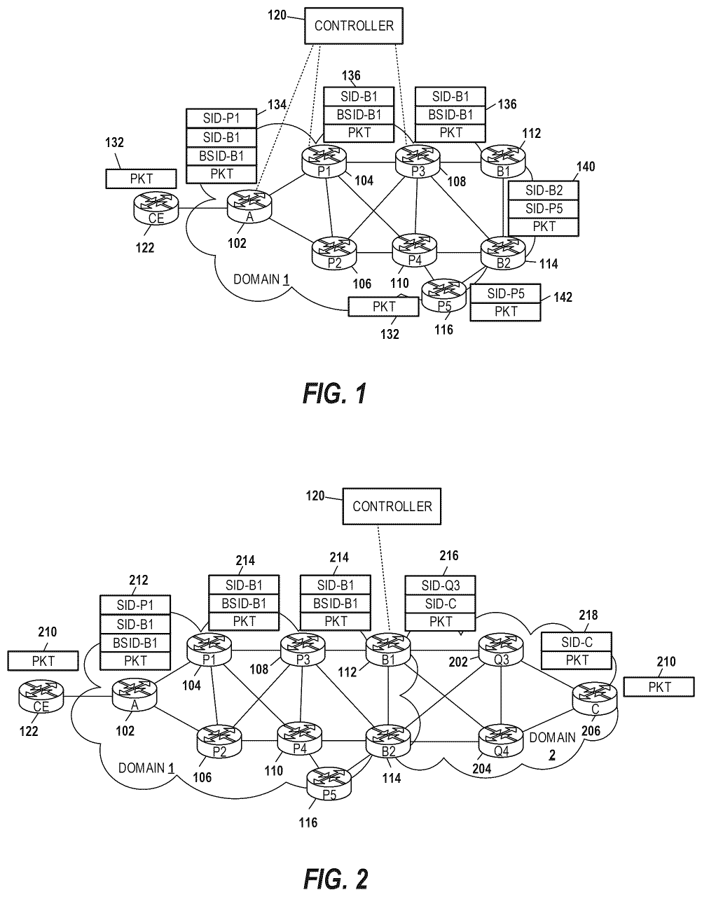

FIG. 1 is a diagram illustrating an example of SR in a single domain. In an embodiment, domain 1 is an SR domain. An SR domain is a collection of nodes (e.g., routers) that are configured to perform SR. For example, domain 1 includes node A 102, node P1 104, node P2 106, node P3 108, node P4 110, node B1 112, node B2 114, and node P5 116 that are configured to perform SR. Domain 1 may also include one or more controllers such as a controller 120 that is configured to communicate with the nodes in domain 1 as indicated by the dash lines. To simplify the diagram, not all dash lines between the controller 120 and each of the nodes in domain 1 are depicted. In an embodiment, the controller 120 may be configured as or implement a path computation element (PCE). The PCE is configured to perform path computation for determining one or more paths in domain 1 for routing packets, setup and maintain the paths (e.g., SR paths) for carrying traffic. Request for Comments (RFC) publication 9050 titled “Path Computation Element Communication Protocol (PCEP) Procedures and Extensions for Using the PCE as a Central Controller (PCECC) of LSPs” published July 2021 (RFC 9050) specifies the procedures and PCEP extensions for using the PCE as the central controller. In an embodiment, the PCE communicates with a path computation client (PCC) application or component implemented on each of the nodes in the SR domain for transmitting/receiving path information. The PCE and PCC are configured to use the path information for determining where to transmit a packet in domain 1.

In domain 1, node P1 104, node P2 106, node P3 108, node P4 110, and node P5 116 are provider (P) routers. Provider routers are routers located in the core of the provider's network. Node A 102, node B1 112, and node B2 114 are provider edge (PE) or border (B) routers. A border router may be an ingress node, an egress node, or both. An ingress node is a node in a domain that is configured to receive packets from routers outside the domain. An egress node is a node in a domain that is configured to transmit (i.e., send) packets to routers outside the domain. For instance, as shown in FIG. 1, node A 102 is an ingress node of domain 1 and is configured to receive a packet (PKT) 132 from a customer edge (CE) router 122. CE router 122 is a router located on the customer premises. CE router 122 may be configured to provide communication between a customer network and a service provider network such as, but not limited to, domain 1.

As stated above, SR supports the creation of explicit paths using a segment list encoded as a stack of SIDs such as labels. The segment list may include different types of SIDs including, but not limited to, adjacency SIDs, node SIDs, and BSIDs. A node SID indicates a loose hop to a node that the packet should pass through on an SR path. A loose hop is a node that is not required to be directly connected to a previous node in the segment list. An adjacency SID specifies a strict single-hop that carries packets over a specific link from one node to another node. In contrast to a loose hop, a strict hop must be directly connected to the previous node in the sequence. A BSID is an SR segment of a node and bound to an SR policy. An SR policy specifies one or more paths (e.g., a set of one or more segment lists or SID lists) for steering/routing packets of traffic/packet flows specified by the SR policy. A node may be configured with multiple SR policies. For instance, a first SR policy may be associated with a first SID list for routing a packet over a first path, and a second SR policy may be associated with a second SID list for routing a packet over a second path. Use of a BSID allows the instantiation of the policy (e.g., a SID list associated with the policy) to be stored only on the node that imposes (i.e., enforces/executes) the policy. Direction of traffic to a node supporting the policy then only requires imposition of the BSID to steer the packet to a node. In the present disclosure, a node on an SR path that has a BSID bound to an SR policy is referred to as a binding node. If the policy changes, only the binding node needs to be updated.

As an example, in FIG. 1, node A 102 is configured to perform SR of the packet 132 by prepending/pushing a segment list of an SR path 1 (A→P1→B1→BSID-B1 (B2→P5)) to the packet 132 to obtain a packet 134. In an embodiment, when SIDs for the SR path are SRv6 SIDs, node A 102 uses H.Encaps to push/prepend the segment list to the packet. H.Encaps is described in RFC publication 8986 titled “Segment Routing over IPv6 (SRv6) Network Programming” published February 2021. The segment list of an SR path 1 includes a node SID of node P1 104 (SID-P1), a node SID of node B1 112 (SID-B1), and a BSID of node B1 112 (BSID-B1). In this example, node B1 112 is a binding node. Node A 102 then forwards the packet 134 to node P1 104 as specified by the first entry or the top SID (e.g., label) in the segment list (i.e., the top of the SID stack). When a node receives a packet with a segment list, the node reads the top SID in the segment list to determine where to route the packet. If the top SID in the segment list is the SID of the node, then the node pops its node SID from the segment list, and then reads the new top SID in the segment list to determine where to route the packet. The term pop means to remove a segment or SID from the top or beginning of the segment list. The term top SID refer to the SR-MPLS SID (i.e., label) or SRv6 SID that is at the top or beginning of the segment list. When a top SID is popped, the SID that was previously under the top SID, if any, is now the top SID. For example, when node P1 104 receives the packet 134, node P1 104 reads the top SID in the segment list of the packet 134. Because the top SID in the segment list in the packet 134 is the SID of node P1 104, node P1 104 pops its node SID (SID-P1) from the top of the segment list in packet 134 to obtain a packet 136. Node P1 then reads the segment/SID that is now at the top of the segment list, which is SID-B1 to determine where to route the packet 136. As stated above, SID-B1 indicates a loose hop node that is not required to be directly connected to a previous node in the segment list. For instance, as shown in FIG. 1, node B1 112 is not directly connected to node P1 104. In an embodiment, node P1 104 is configured to use a locally stored FIB table to determine a next hop/node for routing the packet 136 to node B1 112. In an embodiment, each FIB entry in the FIB table specifies a next hop node and output interface for packets destined for a specific subnet or host (e.g., specifies a next hop node along an IGP shortest path to node B1 112). The locally stored FIB table may be based on routing or path information received from the controller 120. For example, in FIG. 1, node P1 104 determines that node P3 108 is the next hop node for routing the packet 136 to node B1 112. Thus, node P1 104 sends the packet 136 to node P3 108. When node P3 108 receives the packet 136, node P3 108 reads the top SID of the segment list. Because the top SID of the segment list is SID-B1 and not a node SID of node P3 108, node P3 108 does not pop the top SID of the segment list, but instead simply forwards, using information in its locally stored FIB table, the packet 136 to node B1 112. When node B1 112 receives the packet 136, node B1 112 pops the top SID off the segment list to remove its node SID from the segment list. Node B1 112 then reads the segment/SID that is now at the top of the segment list, which is BSID-B1. As stated above, BSID-B1 is a BSID that is bound to an SR policy that is associated with a SID list for specifying a specific path for routing packets. For example, assume BSID-B1 is associated with SID list: <SID-B2, SID-P5>. In this example, node B1 112 replaces BSID-B1 with SID list: <SID-B2, SID-P5> to obtain a packet 140. In an embodiment, when SIDs in the SID list are SRv6 SIDs, node B1 112 pops BSID-B1 from the packet and uses H.Encaps to push/prepend the SID list to the packet. Node B1 112 then sends the packet 140 to node B2 114 as indicated by the top SID in the segment list of the packet 140. When node B2 114 receives the packet 140, node B2 114 reads the top SID in the segment list of the packet 140. Node B2 114 pops its node SID (SID-B2) from the top of the segment list in packet 140 to obtain a packet 142. Node B2 114 then reads the top SID of the segment list in packet 142, which is SID-P5. Node B2 114 sends the packet 142 to node P5 116. When node P5 116 receives the packet 142, node P5 116 pops its node SID (SID-P5) from the top of the segment list in packet 142 to obtain the original packet 132 without any prepended SIDs.

FIG. 2 is a diagram illustrating a first example of SR across domains. In the depicted embodiment, domain 1 includes node A 102, node P1 104, node P2 106, node P3 108, node P4 110, node B1 112, node B2 114, and node P5 116 as described in FIG. 1. Domain 2 includes node B1 112, node B2 114, node Q3 202, node Q4 204, and node C 206. Additionally, in this example, node B1 112 and node B2 114 are configured as border nodes for both domain 1 and domain 2, which means that node B1 112 and node B2 114 can communicate (i.e., route packets directly through) the nodes in both domain 1 and domain 2. For example, node B1 112 can act as an egress node for domain 1 and an ingress node for domain 2, or vice versa. Like FIG. 1, both domain 1 and domain 2 may include one or more domain controllers, such as controller 120, that are configured to setup and maintain various paths for carrying traffic (e.g., SR paths) or other services to the nodes in the corresponding domain. In the depicted embodiment, domain 1 is referred to as an upstream domain and domain 2 is referred to as downstream domain because a packet travels from domain 1 to domain 2 along an SR path 2 (A→P1→B1→BSID-B1 (Q3→C)). For instance, node A 102 receives a packet 210 from CE router 122. Node A 102 prepends the same segment list (i.e., SID-P1, SID-B1, BSID-B1) as described in FIG. 1 to the packet 210 to obtain a packet 212. Node A 102 forwards the packet 212 to node P1 104 as indicated by the top SID in the segment list of packet 212. Node P1 104 pops its node SID (SID-P1) from the top of the segment list in packet 212 to obtain a packet 214. Node P1 104 then reads the segment/SID that is now at the top of the segment list, which is SID-B1. Node P1 104, using a locally stored FIB table determines a next hop/node (e.g., node P3 108) for routing the packet 214 to node B1 112. Node P1 104 sends the packet 214 to node P3 108. When node P3 108 receives the packet 214, node P3 108 reads the top SID of the segment list. As described above, because the top SID of the segment list is SID-B1 and not a node SID of node P3 108, node P3 108 does not pop the top SID of the segment list, but instead simply forwards, using information in its locally stored FIB table, the packet 214 to node B1 112. When node B1 112 receives the packet 214, node B1 112 pops the top SID off the segment list to remove its node SID from the segment list. Node B1 112 then reads the segment/SID that is now at the top of the segment list, which is BSID-B1. In this example, BSID-B1 is a BSID associated with SID list: <SID-Q3, SID-C>. Node B1 112 replaces BSID-B1 in the segment list with the SID list: <SID-Q3, SID-C> to obtain a packet 216. For example, node B1 112 may be configured to perform a procedure to pop BSID-B1 from segment list and then add SID-Q3 and SID-C to the segment list through using H.Encaps to obtain packet 216. Packet 216 is sent to node Q3 202 first and then to node C 206.

After replacing BSID-B1 with the associated SID list in the segment list, node B1 112 then sends the packet 216 to node Q3 202 as indicated by the top SID in the segment list of the packet 216. When node Q3 202 receives the packet 216, node Q3 202 reads the top SID in the segment list of the packet 216. Node Q3 202 pops its node SID (SID-Q3) from the top of the segment list in packet 216 to obtain a packet 218. Node Q3 202 then reads the top SID of the segment list in packet 218, which is SID-C. Node Q3 202 sends the packet 218 to node C 206. When node C 206 receives the packet 218, node C 206 pops its node SID (SID-C) from the top of the segment list in packet 218 to obtain the original packet 210 without any prepended SIDs.

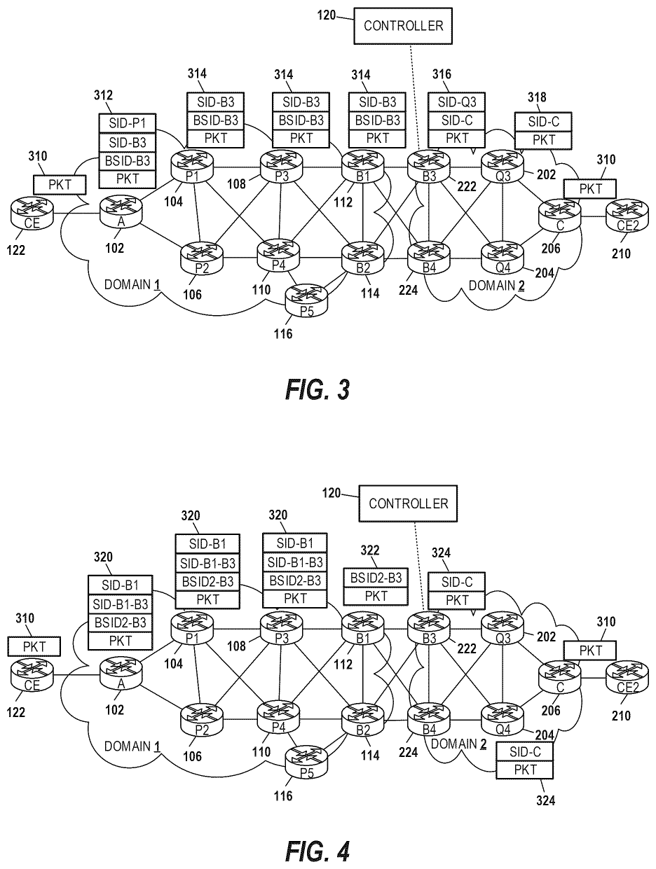

FIG. 3 is a diagram illustrating a second example of SR across domains. In this embodiment, domain 1 and domain 2 do not share a border router as described in FIG. 2. Domain 1 includes node A 102, node P1 104, node P2 106, node P3 108, node P4 110, node B1 112, node B2 114, and node P5 116 as described above. Domain 2 includes node Q3 202, node Q4 204, node C 206, node B3 222, and node B4 224. In the depicted embodiment, node C 206 may be configured to communicate with a CE 210. Domain 1 and domain 2 may include one or more controllers, such as controller 120 shown in FIG. 1, that are configured to compute, setup and maintain paths (e.g., SR paths) for carrying traffic or other services to the nodes in the corresponding domain. Node B1 112 and node B2 114 are border nodes for domain 1. Node B3 222 and node B4 224 are border nodes for domain 2. The border nodes are configured to enable packets to be communicated across domain 1 and domain 2. In some embodiments, a first border node of a domain (e.g., node B3 222 of domain 2) may be configured as a primary border node of the domain and a second border node (e.g., node B4 224) may be configured as a backup or alternate border node of the domain that can be used when the primary border node fails.

In the depicted embodiment, node A 102 receives packet 310 from CE router 122 that is to be routed along SR path 3 (A→P1→B3→BSID-B3 (Q3→C)). Node A 102 prepends segment list <SID-P1, SID-B3, BSID-B3> to the packet 310 to obtain a packet 312, wherein BSID-B3 is a binding SID of node B3 222 and associated with SID list <SID-Q3, SID-C>. Thus, node B3 222 is a binding node. Node A 102 forwards the packet 312 to node P1 104 as specified by the top SID in the segment list of packet 312. Node P1 104 pops its node SID (SID-P1) from the top of the segment list in packet 312 to obtain a packet 314. Node P1 104 then reads the segment/SID that is now at the top of the segment list, which is SID-B3. Node P1 104, using its locally stored FIB table, determines a next hop/node (e.g., node P3 108) for routing the packet 314 to node B3 222. In this example, node P1 104 sends the packet 314 to node P3 108. When node P3 108 receives the packet 314, node P3 108 reads the top SID of the segment list. As described above, because the top SID of the segment list is SID-B3 and not a node SID of node P3 108, node P3 108 does not pop the top SID of the segment list, but instead simply forwards, using information in its locally stored FIB table, the packet 314. In this example, node P3 108 forwards the packet 314 to node B1 112. When node B1 112 receives the packet 314, node B1 112 reads the top SID of the segment list, which is SID-B3, and forwards the packet 314 to node B3 222 in domain 2. When node B3 222 receives the packet 314, node B3 222 pops the top SID off the segment list to remove its node SID from the segment list. Node B3 222 then reads the segment/SID that is now at the top of the segment list, which is BSID-B3. In this example, BSID-B3 is a BSID that is associated with SID list: <SID-Q3, SID-C>. Node B3 222 replaces BSID-B3 with SID list: <SID-Q3, SID-C> to obtain a packet 316. In an embodiment, when SIDs in the SID list are SRv6 SIDs, node B3 222 pops BSID-B3 from the packet 314 and uses H.Encaps to push/prepend the SID list to the packet 314 to obtain the packet 316. Node B3 222 sends the packet 316 to node Q3 202 as indicated by the top SID in the segment list of the packet 316. When node Q3 202 receives the packet 316, node Q3 202 pops its node SID from the top of the segment list in packet 316 to obtain a packet 318. Node Q3 202 sends the packet 318 according to the FIB entry for SID-C. When node C 206 receives the packet 318, node C 206 pops its node SID from the top of the segment list in packet 318 to obtain the original packet 310. In an embodiment, node C 206 sends the packet 310 to CE 210.

FIG. 4 is a diagram illustrating a third example of SR across domains. In particular, FIG. 4 depicts routing of the packet 310 across domain 1 and domain 2, as described in FIG. 3, along SR path 4 (A→B1→B1-B3→BSID2-B3 (B3-Q4→C)). For example, as shown in FIG. 4, when node A 102 receives packet 310 from CE router 122, node A 102 prepends segment list <SID-B1, SID-B1-B3, BSID2-B3> to the packet 310 to obtain a packet 320, wherein BSID2-B3 is another BSID of node B3 222 and associated with SID list <SID-B3-Q4, SID-C>. Again, node B3 222 is a binding node in this example. As described above, the top SID of the segment list is SID-B1, which indicates that node B1 112 is a loose hop. Thus, node A 102 determines, using its locally stored FIB table, the next hop for forwarding the packet 320 to node B1 112. In this example, node A 102 determines the next hop along a shortest path to node B1 112 is node P1 104. Thus, node A 102 sends the packet 320 to node P1 104. When node P1 104 receives the packet 320, node P1 104 does not pop the top SID of the segment list because the top SID is the SID of node B1 112, and not the SID of node P1 104. Instead, node P1 104, using information from its locally stored FIB table, simply forwards the packet 320 to node P3 108. Similarly, when node P3 108 receives the packet 320, node P3 108 simply forwards, using information from its locally stored FIB table, the packet 320 to node B1 112. When node B1 112 receives the packet 320, node B1 112 pops the top SID of the segment list to remove its node SID (SID-B1). Node B1 112 then reads the segment/SID that is now at the top of the segment list, which is SID-B1-B3. SID-B1-B3 is an adjacency SID. As stated above, an adjacency SID in the segment list specifies a strict single-hop that carries packets over a specific link from one node to another node. In this case, SID-B1-B3 specifies a strict single-hop for carrying packets over a specific link from node B1 112 to node B3 222. Node B1 112 pops SID-B1-B3 from the segment list to obtain a packet 322 as shown in FIG. 4. Node B1 112 then sends the packet 322 over the specific link from node B1 112 to node B3 222 specified by the adjacency SID. When node B3 222 receives the packet 322, node B3 222 reads the top SID of the segment list, which is BSID2-B3. BSID2-B3 represents a second or different BSID of node B3 222 from BSID-B3 that was in the segment list of the packet 314 in FIG. 3. For instance, BSID2-B3 may be bound to an SR policy that is associated with a different SID list than the SID list associated with the SR policy bound to BSID-B3. For example, BSID2-B3 in FIG. 4 may be a BSID associated with SID list: <SID-B3-Q4, SID-C>, whereas BSID-B3 in FIG. 3 is associated with SID list: <SID-Q3, SID-C>. Using this example, node B3 222 replaces BSID2-B3 in the segment list with SID list: <SID-B3-Q4, SID-C>. In an embodiment, when SIDs in the SID list are SRv6 SIDs, node B3 222 pops BSID2-B3 from the packet 322 and uses H.Encaps to push/prepend the SID list to the packet 322. As described above, SID-B3-Q4 is an adjacency SID that specifies a strict single-hop for carrying packets over a specific link from node B3 222 to node Q4 204. As stated above, prior to transmitting the packet over the specific link from node B3 222 to node Q4 204 specified by SID-B3-Q4, node B3 222 pops SID-B3-Q4 from the segment list to obtain a packet 324 as shown in FIG. 4. When node Q4 204 receives the packet 324, node Q4 204 reads the top SID of the segment list in the packet 324, which is SID-C. Node Q4 204 routes, using information from its locally stored FIB table, the packet 324 to node C 206. When node C 206 receives the packet 324, node C 206 pops its node SID from the top of the segment list in packet 324 to obtain the original packet 310. In an embodiment, node C 206 sends the packet 310 to CE 210.

As shown above, a BSID may be specified as a segment in a segment list for routing a packet using SR within a single domain or across domains. Use of a BSID allows the instantiation of a SR policy associated with a SID list (i.e., a particular route) to be implemented at a node on a SR path. However, because the policy is stored only on the binding node that needs to impose the policy, when the binding node fails, the network may no longer be able to properly forward traffic on that SR path. Accordingly, the present disclosure describes various embodiments that provide protection for the BSIDs of a node on a SR path (i.e., a binding node) when the binding node fails. In particular, the disclosed embodiments provide SR binding protection applicable to an SR path in a single domain, an SR path that crosses domains operated by one (i.e., the same) administrator/provider, and an SR path that crosses domains operated by different administrators/providers. For example, when domain 1 and domain 2 in FIG. 2 are administrated (or owned) by two different providers, the SID-list 1<SID-Q3, SID-C> associated with BSID-B1 cannot be distributed into domain 1, and can only be distributed to other border nodes such as B2 crossing domain 1 and domain 2. The same problems occur when node B3 222 in FIG. 3 and FIG. 4 fails. Thus, when a binding node fails, there is a need to be able to fast reroute (FRR) a packet with a BSID of the failed node to enable the packet to be forwarded to a final destination node in the same domain or in a different domain.

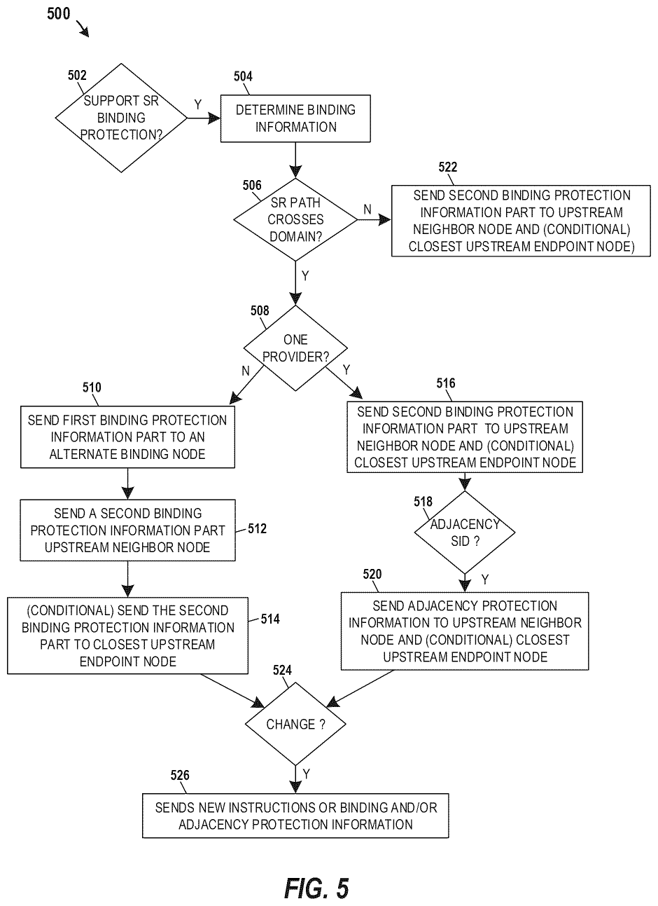

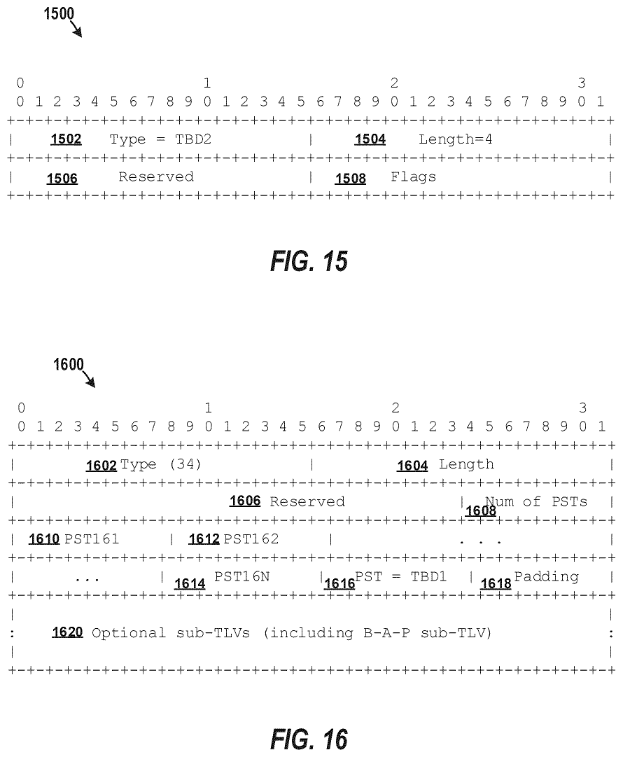

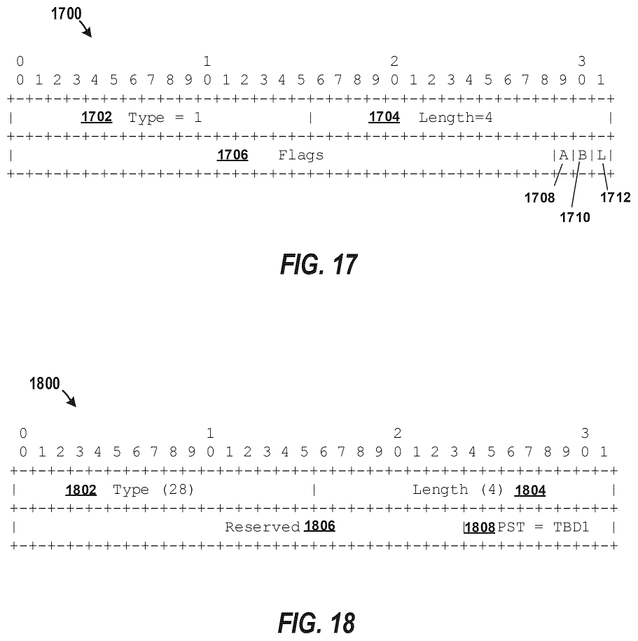

FIG. 5 is a flowchart illustrating a method 500 for providing SR binding protection according to an embodiment of the present disclosure. In an embodiment, the method 500 is implemented by a controller of a domain such as the controller 120 in FIG. 1. In an embodiment, the controller may also be a PCE of the domain. In the depicted embodiment, the controller, at step 502, determines whether a node in the domain support SR binding protection. In an embodiment, a node and the controller are configured to exchange capability information to determine whether the node (i.e., the PCC running on the node) and controller both support SR binding protection for binding node on an SR path. In an embodiment, the binding node is a border node. In some embodiments, the binding node may be a border node of two domains such as node B1 112 in FIG. 2. In an embodiment, a neighbor node of a binding node and the controller exchange capability of distributing binding and adjacency protection information using BINDING ADJACENCY PROTECTION (BAP) CAPABILITY Sub-Type-Length-Value (sub-TLV) (illustrated in FIG. 15), which is included in a PATH_SETUP_TYPE_CAPABILITY TLV (illustrated in FIG. 16) in a PCE Communication Protocol (PCEP) OPEN message. PCEP OPEN message is described in RFC publication 5440 titled “Path Computation Element (PCE) Communication Protocol (PCEP)” published in March 2009 (RFC 5440). In another embodiment, a neighbor node of a binding node and the controller exchange capability of distributing binding and adjacency protection information using a PCECC-CAPABILITY sub-TLV (illustrated in FIG. 17), which is included in a PATH_SETUP_TYPE_CAPABILITY TLV in Open message.

When the node and the controller both support SR binding protection, the controller, at step 504, determines binding information of a binding node on an SR path. In an embodiment, the binding information includes a BSID of the border node (BSID-B) and a list of SIDs associated with BSID-B. In the present disclosure, the list of SIDs associated with BSID-B is referred to as SID-list 1 or a binding SID list or SID-list a (wherein a is short for active) representing active path segment for BSID-B. In an embodiment, the controller receives the binding information from the binding node. In another embodiment, the controller determines the binding information and sends the binding information to the binding node. In an embodiment, after receiving the binding information, the controller may determine binding protection information based on the binding information of the binding node. Binding protection information is information that is distributed to one or more nodes, and is used by the receiving node to support routing of a packet along an SR path that includes a binding node that has failed. As further described below, the binding protection information may include a first binding protection information part and a second binding protection information part.

For instance, in an embodiment, the controller, at step 506, determines whether the SR path crosses from a first domain to a second domain. When the SR path crosses from the first domain to the second domain, the controller, at step 508, determines whether the first domain and the second domain are administrated by one provider or two different providers. When the first domain and the second domain are administrated by two different providers, the controller, at step 510, is configured to send a first binding protection information part for the binding node to an alternate binding node. For example, in FIG. 3, node B4 224 may be selected as an alternated binding node for binding node B3 222. In an embodiment, the first binding protection information part includes a BSID of the alternate border node (BSID-aB) and a list of SIDs, referred to as SID-list 2 or a corresponding SID list or SID-list c (wherein c is short for corresponding) representing a path segment corresponding to the SID-list 1, binding SID list or SID-list a. SID-list 2 is associated with BSID-aB and corresponds to SID-list 1. In an embodiment, the correspondence between the binding SID list (SID-list 1) and SID-list 2 is based on whether the first SID in SID-list 1 is an adjacency SID or a node SID. In one embodiment, when the first SID in SID-list 1 is an adjacency SID from the border node to a remote node (e.g., SID-B3-Q4 in FIG. 4), then SID-list 2 contains the node SID of the remote node and all the SIDs in SID-list 1 excluding the first SID. Replacing the first SID in SID-list 1 with the node SID of the remote node generates the corresponding SID list (i.e., SID-list 2). For example, as described in FIG. 4, suppose that a BSID of node B3 222 (BSID2-B3) is associated with the list of SIDs <SID-B3-Q4, SID-C>, which is SID-list 1. SID-B3-Q4 is the first SID in SID-list 1. SID-B3-Q4 is an adjacency SID having a remote node of Q4. The node SID of remote node Q4 is SID-Q4. Thus, replacing the first SID in SID-list 1 with SID-Q4 generates corresponding SID list <SID-Q4, SID-C>. In an embodiment, when the first SID in SID-list 1 is a node SID, the corresponding SID list (i.e., SID-list2) is the same as the SID-list 1.

Additionally, when the first domain and the second domain are administrated by two different providers, the controller, at step 512, is configured to send a second binding protection information part for the binding node to an upstream neighbor node of the binding node on the SR path. For example, in FIG. 3, node B1 112 in domain 1 is an upstream neighbor node of binding node B3 222 in domain 2 on the SR path. In an embodiment, the second binding protection information part includes the BSID of the binding node (BSID-B), a backup SID list (referred to as SID-list 3 or SID-list b, wherein b is short for backup), an identifier (ID) of the binding node (ID-B), and an instruction. The backup SID list (i.e., SID-list 3 or SID-list b) represents a backup path to be used when the binding node fails. In an embodiment, the backup SID list contains a node SID of the alternate binding node (SID-aB) and the BSID of the alternate binding node (BSID-aB) (e.g., SID-list 3: <SID-aB, BSID-aB>). In an embodiment, the instruction instructs the upstream neighbor node to use the second binding protection information part (i.e., the BSID-B, SID-list 3 and ID-B) for protecting the BSID of the binding node if the binding node fails. For example, as will be further described, when the binding node fails, the upstream neighbor node is configured to use the backup SID list (SID-list 3) to route the packet to the alternate binding node (SID-aB). In some embodiments, the instruction may be inferred from the second binding protection information part. For example, in some embodiments, nodes receiving the second binding protection information part (i.e., the BSID-B, SID-list 3 and ID-B) are preconfigured to use the second binding protection information part for protecting the BSID of the binding node.

Additionally, when the first domain and the second domain are administrated by two different providers, the controller, at step 514, is configured to send the second binding protection information part to the closest upstream endpoint node (e.g., node P1 102 in FIG. 3) of the binding node (e.g., node B3 222 in FIG. 3) if the binding node is a loose hop (e.g., SID-B3 in the segment list of the SR path) and the upstream endpoint node is not a neighbor node of the binding node. An upstream endpoint node is a node upstream of the binding node along the SR path and the SID of the node is specified in the SID list of the SR path. For example, node P1 102 in FIG. 3 is a node upstream of the binding node B3 222 in FIG. 3 along the SR path and SID-P1 is in the segment list of packet 312 in FIG. 3. Additionally, in FIG. 3, binding node B3 222 is a loose hop (e.g., SID-B3 in the segment list of the SR path) and node P1 102 is the closest upstream endpoint node to binding node B3 222 in the SR path. In some embodiments, there may be no upstream endpoint node. For example, in FIG. 4, while node B1 112 is a node that is upstream of node B3 222 along the SR path and the SID of node B1 112 (SID-B1) is specified in the SID list of the SR path, node B1 112 has a strict single hop (SID-B1-B3) to binding node B3 222. Thus, node B3 33 is not a loose hop, node B1 112 is an upstream neighbor node of binding node B3 222 and not an upstream endpoint node of binding node B3 222.

In an embodiment, when the controller, at step 508, determines that the first domain and the second domain are administrated by one provider, the controller does not send the first binding protection information part (i.e., BSID-aB and SID-list 2) for the binding node to an alternate binding node. Instead, the controller, at step 516, is configured to send only the second binding protection information part to an upstream neighbor node of the binding node on the SR path and to a closest upstream endpoint node of the binding node, if any, when the binding node is a loose hop. In an embodiment, the backup SID list (SID-list 3) in the second binding protection information part includes a node SID of the alternate binding node (SID-aB) and the SIDs in SID-list 2 (i.e., <SID-aB, SIDs in SID-list 2>). For example, in FIG. 3, for binding node B3 222 having BSID-B3 and alternate binding node B4 224, the SID-list 1 associated with BSID-B3 of binding node B3 222 is <SID-Q3, SID-C>. Because the first SID in SID-list 1 is a node SID (i.e., SID-Q3), then the corresponding SID list (SID-list 2) is the same as SID-list 1. Thus, the backup SID list (SID-list 3) is <SID-B4, SID-Q3, SID-C>.

In an embodiment, the controller, at step 518, determines whether there is an adjacency SID of a node in the SR path used for crossing the two domains or the next hop of the node is in the second domain. A node satisfying this condition is referred to in the present disclosure as an adjacency node. For example, in FIG. 4, SID-B1-B3 is an adjacency SID of a node in the SR path (i.e., node B1 112) that is used for crossing the two domains (from domain 1 to domain 2). Thus, in FIG. 4, node B1 112 is an adjacency node. When there is an adjacency node, the controller, at step 520, is configured to send adjacency protection information to an upstream neighbor node (e.g., node P3 108 in FIG. 4) of the adjacency node and, if any, a closest upstream endpoint node (none in FIG. 4) when the adjacency node is a loose hop. In an embodiment, the adjacency protection information includes the adjacency SID of the adjacency node (e.g., SID-B-R representing an adjacency SID from node B to remote node R), a node SID of the remote node of the adjacency SID (e.g., SID-R), and an ID of the adjacency node (e.g., ID-B). As further described below, the upstream neighbor node and the closest upstream endpoint node are configured to use the adjacency protection information to route a packet when the adjacency node fails.

Similarly, in an embodiment, when the controller, at step 506, determines that the SR path does not cross the second domain (i.e., the SR path is in a single domain as shown in FIG. 1), the controller, at step 522, is configured to send only the second binding protection information part to an upstream neighbor node of the binding node on the SR path (e.g., node P3 108) and to a closest upstream endpoint node (e.g., node P1 104) when the binding node is a loose hop. When the SR path does not cross the second domain, the backup SID list (SID-list 3) in the second binding protection information part is the same as the corresponding SID list (SID-list 2). For example, in FIG. 1, the SID-list 1 associated with BSID-B1 of binding node B1 112 is <SID-B2, SID-P5>. Because the first SID in SID-list 1 is a node SID (i.e., SID-B2), then the corresponding SID list (SID-list 2) is the same as SID-list 1 (i.e., SID-list 2: <SID-B2, SID-P5>). Therefore, the backup SID list in this example is <SID-B2, SID-P5>.

In an embodiment, the controller is configured to continue to monitor for changes to the binding information or adjacency information of an SR path and update the nodes in the SR path based on any change. For example, after transmitting the binding protection information and/or the adjacency protection information to a node, the controller, at step 524, is configured to determine whether the binding and/or adjacency information of the SR path or the binding and/or adjacency information of the nodes in the SR path have changed (e.g., removed or altered), and if so, the controller, at step 526, sends new instructions or binding and/or adjacency protection information to the corresponding nodes (e.g., the upstream neighbor and the closest upstream endpoint node and/or the alternate binding node) to alter the SR binding and/or adjacency protection information on the respective node.

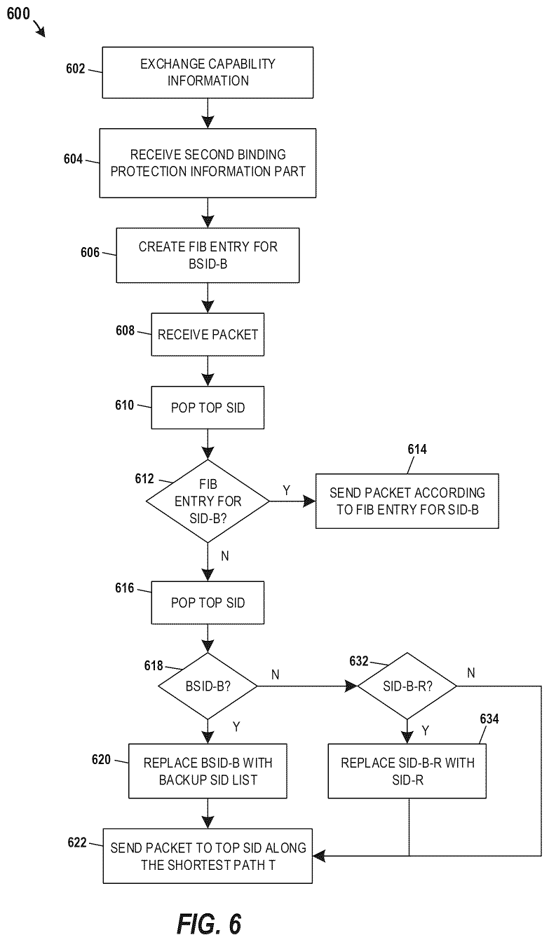

FIG. 6 is a flowchart illustrating a method 600 for providing SR binding protection according to an embodiment of the present disclosure. In an embodiment, the method 600 is implemented by an upstream endpoint node of a binding node on an SR path. As described above, an upstream endpoint node is a node upstream of the binding node along the SR path and the SID of the node is specified in the SID list of the SR path. In an embodiment, the method 600 is implemented by the closest upstream endpoint node of the binding node along the SR path when the binding node is a loose hop on the SR path. In other words, the node SID of the closest upstream endpoint node immediately precedes the node SID of the binding node in the segment list of the SR path.

At step 602, the upstream endpoint node exchanges capability information with a controller informing the controller that the upstream endpoint node supports SR binding protection. In an embodiment, the upstream endpoint node exchange capability of distributing binding and adjacency protection information using a BINDING ADJACENCY PROTECTION (BAP) CAPABILITY sub-TLV in a PCEP OPEN message. After exchanging capability information, the upstream endpoint node, at step 604, receives a second binding protection information part (BSID-B, SID-list 3 and ID-B) from the controller. As described above, in an embodiment, the second binding protection information part includes the BSID of the binding node (BSID-B), a backup SID list (referred to as SID-list 3), and an ID of the binding node (ID-B). In some embodiments, the second binding protection information further includes an instruction. In an embodiment, based on the instruction, the upstream endpoint node, at step 606, creates a FIB entry for BSID-B of the node with ID-B. In an embodiment, the FIB entry instructs the upstream endpoint node to replace BSID-B in a packet with SID-list 3 and sends the packet along the shortest path to the top SID in the packet according to the FIB entry for the top SID. In an embodiment, when SIDs in SID list 3 are SRv6 SIDs, the upstream endpoint node pops BSID-B from the packet and uses H.Encaps to push/prepend SID list 3 to the packet. In an embodiment, when there is no FIB entry for node SID of the binding node (SID-B) as top SID of a packet received, which is followed by BSID-B, the upstream endpoint node is configured or instructed to use the new FIB entry for BSID-B of the binding node after popping (i.e., removing) SID-B.

For example, at step 608, the upstream endpoint node receives a packet of the SR path. The upstream endpoint node, at step 610, pops the top SID to remove the node SID of the upstream endpoint node from the segment list of the packet. Because the upstream endpoint node is the closest upstream endpoint node to the binding node on an SR path, the top SID of the segment list now contains the node SID of the binding node (SID-B). The upstream endpoint node, at step 612, determines whether there is a FIB entry for the node SID of the binding node (SID-B). When there is a FIB entry for SID-B (e.g., when the binding node has not failed or IGP has not converged on the failure of the binding node), the upstream endpoint node, at step 614, sends the packet according to the FIB entry for SID-B. When there is no FIB entry for SID-B (e.g., when the binding node has failed and IGP has converged on the failure of the binding node, the FIB entry for SID-B is removed), the upstream endpoint node, at step 616, pops the top SID to remove the node SID of the binding node (SID-B). The upstream endpoint node, at step 618, determines whether the SID following the SID that was removed (i.e., SID after SID-B) is a binding SID of the binding node (i.e., BSID-B). When the upstream endpoint node determines that the binding SID of the binding node (BSID-B) follows the node SID of the binding node (SID-B) in the segment list of the packet, the upstream endpoint node, at step 620, replaces BSID-B in the segment list with the backup SID list (SID-list 3) according to the created FIB entry for BSID-B of the binding node. In an embodiment, when SIDs in the backup SID list (SID list 3) are SRv6 SIDs, the upstream endpoint node pops BSID-B from the packet and uses H.Encaps to push/prepend the backup SID list SID list 3 to the packet. The upstream endpoint node, at step 622, sends the packet along the shortest path to the top SID in the packet, which is the first SID in the backup SID list, according to the FIB entry for the top SID. In an embodiment, when the SID following the SID that was removed (i.e., SID after SID-B) is not a binding SID of the binding node (i.e., BSID-B), the upstream endpoint node, at step 632, determines whether the SID following the SID that was removed is an adjacency SID (i.e., SID-B-R for an adjacency from node B to node R). When the SID following the top SID that was removed is an adjacency SID (i.e., SID-B-R), the upstream endpoint node, at step 634, replaces the adjacency SID (i.e., SID-B-R) in the segment list with a node SID of the remote node of the adjacency (i.e., SID-R). The upstream endpoint node, at step 622, sends the packet along the shortest path to the top SID in the packet.

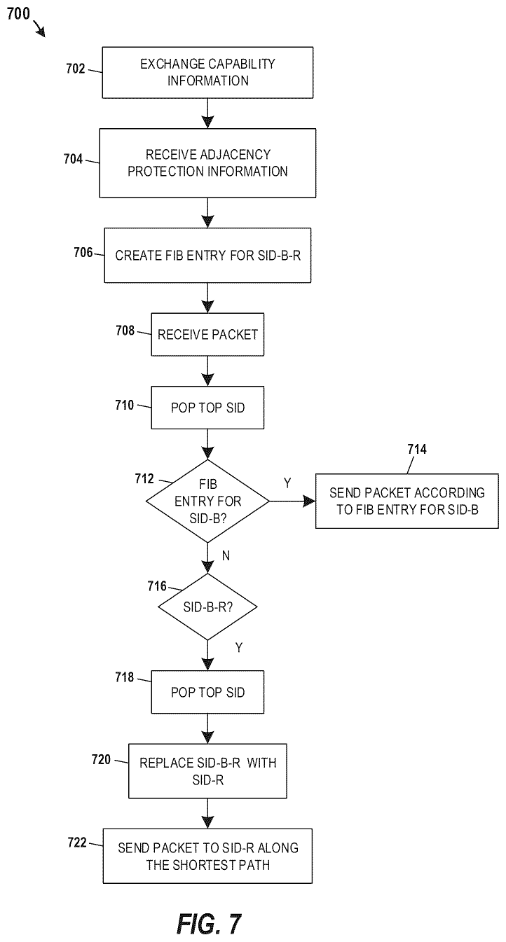

FIG. 7 is a flowchart illustrating a method 700 for providing SR adjacency protection according to an embodiment of the present disclosure. In an embodiment, the method 700 is implemented by a closest upstream endpoint node of an adjacency node along the SR path when the adjacency node is a loose hop on the SR path. As stated above, an adjacency node is a node in the SR path in which there is an adjacency SID of the node in the segment list for crossing two domains or the next hop of the node is in a second domain. At step 702, the upstream endpoint node exchanges capability information with a controller informing the controller that the upstream endpoint node supports SR adjacency protection. In an embodiment, the upstream endpoint node exchanges capability of distributing adjacency protection information using a BINDING ADJACENCY PROTECTION (BAP) CAPABILITY sub-TLV in a PCEP OPEN message. After exchanging capability information, the upstream endpoint node, at step 704, receives adjacency protection information (SID-B-R, SID-R and ID-B) from the controller. As described above, in an embodiment, the adjacency protection information includes the adjacency SID of the adjacency node (e.g., SID-B-R representing an adjacency SID from node B to remote node R), a node SID of the remote node of the adjacency SID (e.g., SID-R), and an ID of the node (e.g., ID-B).

In an embodiment, the upstream endpoint node, at step 706, creates a FIB entry for SID-B-R of the node with ID-B. In an embodiment, the FIB entry instructs the upstream endpoint node to replace SID-B-R in a packet with SID-R and sends the packet along the shortest path to the SID-R according to the FIB entry for SID-R. In an embodiment, when there is no FIB entry for node SID of the adjacency node (SID-B) as top SID of a packet received, which is followed by SID-B-R, the upstream endpoint node is configured or instructed to use the new FIB entry for SID-B-R after popping SID-B from the top SID of the segment list of the packet.

For example, at step 708, the upstream endpoint node receives a packet of the SR path that includes adjacency SID: SID-B-R. The upstream endpoint node, at step 710, pops the top SID to remove the node SID of the upstream endpoint node from the segment list of the packet. Because the upstream endpoint node is the closest upstream endpoint node to the adjacency node on an SR path, the top SID of the segment list now contains a node SID of the adjacency node (SID-B). The upstream endpoint node, at step 712, determines whether there is a FIB entry for the node SID of the adjacency node (SID-B). When there is a FIB entry for SID-B (e.g., when the adjacency node has not failed or IGP has not converged on the failure of the adjacency node), the upstream endpoint node, at step 714, sends the packet according to the FIB entry for SID-B. When there is no FIB entry for SID-B (e.g., when the adjacency node has failed and IGP has converged on the failure of the adjacency node, the FIB entry for SID-B is removed), the upstream endpoint node, at step 716, determines whether the SID following the top SID (i.e., the SID after SID-B) is an adjacency SID of the adjacency node (i.e., SID-B-R). When the upstream endpoint node determines that the adjacency SID of the adjacency node (SID-B-R) follows the node SID of the adjacency node (SID-B) in the segment list of the packet, the upstream endpoint node, at step 718, pops the top SID to remove the node SID of the adjacency node (SID-B) so the adjacency SID of the adjacency node (SID-B-R) becomes the new top SID of the segment list of the packet. According to the created FIB entry for SID-B-R of the adjacency node, the upstream endpoint node, at step 720, replaces SID-B-R in the segment list with a node SID of the remote node (SID-R). In an embodiment, when SIDs in the segment list are SRv6 SIDs, the upstream endpoint node pops/removes SID-B-R from the packet and uses H.Encaps to push/prepend the node SID (SID-R) to the packet. The upstream endpoint node, at step 722, sends the packet along the shortest path to SID-R according to the FIB entry for SID-R.

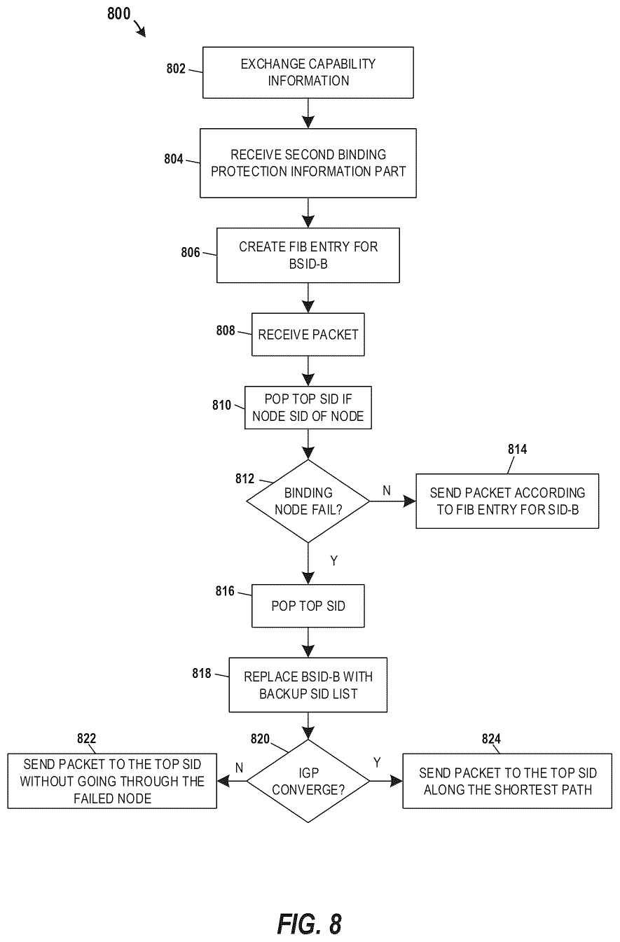

FIG. 8 is a flowchart illustrating a method 800 for providing SR binding protection according to an embodiment of the present disclosure. In an embodiment, the method 800 is implemented by an upstream neighbor node of a binding node on an SR path. An upstream neighbor node is a node upstream of the binding node along the SR path and the binding node is a next hop of the node. At step 802, the upstream neighbor node exchanges capability information with a controller informing the controller that the upstream neighbor node supports SR binding protection. In an embodiment, the upstream neighbor node exchanges capability of distributing binding and adjacency protection information using a BINDING ADJACENCY PROTECTION (BAP) CAPABILITY sub-TLV in a PCEP OPEN message. After exchanging capability information, the upstream neighbor node, at step 804, receives a second binding protection information part (BSID-B, SID-list 3 and ID-B) from the controller. The second binding protection information part includes the BSID of the binding node (BSID-B), a backup SID list (referred to as SID-list 3 or SID-list b), and an ID of the binding node (ID-B). In some embodiments, the second binding protection information further includes an instruction. In an embodiment, based on the instruction, the upstream neighbor node, at step 806, creates a FIB entry for BSID-B of the node with ID-B. In an embodiment, the FIB entry instructs the upstream neighbor node to replace BSID-B in a packet with SID-list 3.

At step 808, the upstream neighbor node receives a packet of the SR path that includes a binding SID of a binding node. The binding node is a downstream neighbor of the upstream neighbor node on the SR path. When the top SID in the packet is the node SID of the upstream neighbor node, the upstream neighbor node, at step 810, pops the top SID to remove the node SID of the upstream neighbor node from the segment list of the packet. The upstream neighbor node, at step 812, determines whether the binding node has failed. For example, when the binding node fails and before IGP converges on the failure, the upstream neighbor node may detect the failure of the binding node using a fast failure detection method such as using Bidirectional Forwarding Detection (BFD) protocol. BFD is a detection protocol designed to provide fast forwarding path failure detection in a forwarding path between two adjacent routers. BFD is described in RFC publication 5880 titled “Bidirectional Forwarding Detection (BFD)” published in June 2010 (RFC 5880). In some embodiments, the upstream neighbor node may determine whether the binding node has failed prior to receiving the packet. At step 814, when the binding node has not failed, the upstream neighbor node is configured to send the packet according to the FIB entry for the top SID in the packet, which is SID-B. In an embodiment, to determine that the failed neighbor node is a binding node on the SR path, the upstream neighbor node determines whether the SID below the top SID is a binding SID of the binding node (i.e., BSID-B), and if so, the upstream neighbor node, at step 816, pops the top SID to remove SID-B. At step 818, the upstream neighbor node, replaces BSID-B in the segment list with the backup SID list (SID-list 3) according to the FIB entry for BSID-B of the binding node. In an embodiment, when SIDs in the segment list are SRv6 SIDs, the upstream neighbor node pops/removes BSID-B from the packet and uses H.Encaps to push/prepend the backup SID list (SID-list 3) to the packet. At step 820, the upstream neighbor node determines whether IGP has converged on the failure of the binding node (e.g., whether there is a FIB entry to the binding node). In an embodiment, when there is a FIB entry to the binding node, the upstream neighbor node determines that IGP has not converged on the failure of the binding node. When the upstream neighbor node determines that IGP has not converge on the failure of the node, the upstream neighbor node, at step 822, sends the packet to the top SID in the packet (i.e., the first SID node in SID-list 3) without going through the failed node. In an embodiment, the packet is rerouted using Topology Independent-Loop Free Alternate (TI-LFA)). TI-LFA provides fast-reroute protection by allowing a point of local repair (PLR) to construct a loop free backup path and imposes the constraint that the backup path used by the PLR be the same path that a packet takes once the IGP converges for a given failure. When the upstream neighbor node determines that IGP has converged on the failure of the node, the upstream neighbor node, at step 824, sends the packet to the top SID in the packet along the shortest path to the top SID in the packet according to the FIB entry for the top SID.

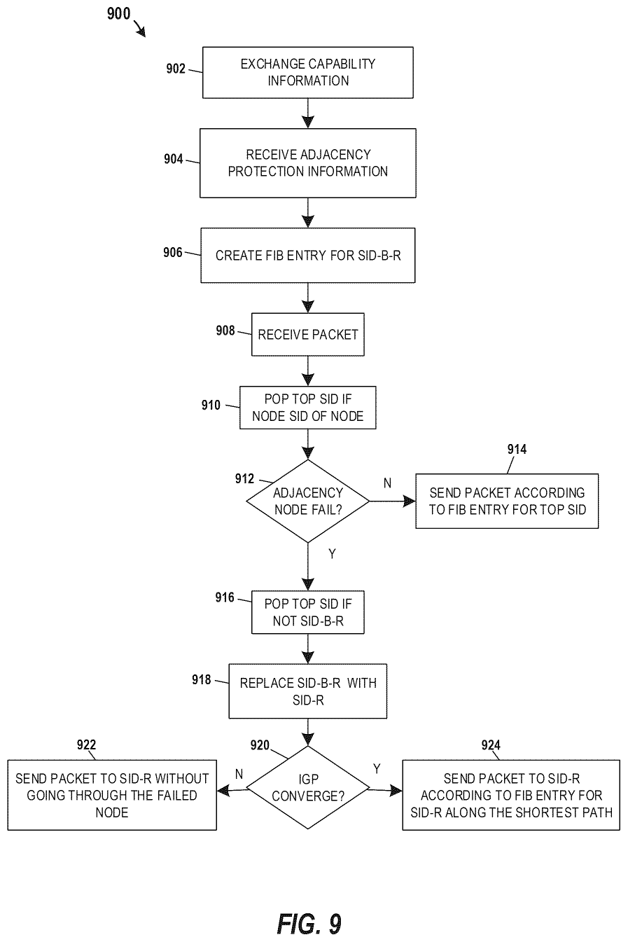

FIG. 9 is a flowchart illustrating a method 900 for providing SR adjacency protection according to an embodiment of the present disclosure. In an embodiment, the method 900 is implemented by an upstream neighbor node of an adjacency node on an SR path. An upstream neighbor node is a node upstream of the adjacency node along the SR path and the adjacency node is a next hop of the node. At step 902, the upstream neighbor node exchanges capability information with a controller informing the controller that the upstream neighbor node supports SR binding and/or adjacency protection. In an embodiment, the upstream neighbor node exchange capability of distributing binding and/or adjacency protection information using a BINDING ADJACENCY PROTECTION (BAP) CAPABILITY sub-TLV in a PCEP OPEN message. After exchanging capability information, the upstream neighbor node, at step 904, receives adjacency protection information (SID-B-R, SID-R and ID-B) from the controller. As described above, in an embodiment, the adjacency protection information includes the adjacency SID of the adjacency node (e.g., SID-B-R representing an adjacency SID from node B to remote node R), a node SID of the remote node of the adjacency SID (e.g., SID-R), and an ID of the node (e.g., ID-B). In an embodiment, the upstream neighbor node, at step 906, creates a FIB entry for SID-B-R of the node with ID-B. In an embodiment, the FIB entry instructs the upstream neighbor node to replace SID-B-R in a packet with SID-R. In an embodiment, when SID-B-R is SRv6 SID, the upstream neighbor node pops/removes SID-B-R from the packet and uses H.Encaps to push/prepend the node SID (SID-R) to the packet.

At step 908, the upstream neighbor node receives a packet of the SR path that includes adjacency SID: SID-B-R. The adjacency node is a downstream neighbor of the upstream neighbor node on the SR path. When the top SID in the packet is the node SID of the upstream neighbor node, the upstream neighbor node, at step 910, pops the top SID to remove the node SID of the upstream neighbor node from the segment list of the packet. The upstream neighbor node, at step 912, determines whether the adjacency node has failed. For example, when the adjacency node fails and before IGP converges on the failure, the upstream neighbor node may detect the failure of the adjacency node using a fast failure detection method such as using BFD protocol. In some embodiments, the upstream neighbor node may determine whether the adjacency node has failed prior to receiving the packet. At step 914, when the adjacency node has not failed, the upstream neighbor node is configured to send the packet according to the FIB entry for top SID in the packet. In an embodiment, when the adjacency node has failed, the upstream neighbor node, at step 916, pops any SIDs in the segment list of the packet preceding SID-B-R (e.g., SID-B may precede SID-B-R in the segment list). At step 918, the upstream neighbor node, replaces SID-B-R in the segment list with SID-R according to the FIB entry for SID-B-R of the adjacency node. In an embodiment, when SID-B-R is SRv6 SID, the upstream neighbor node pops/removes SID-B-R from the packet and uses H.Encaps to push/prepend the node SID (SID-R) to the packet. At step 920, the upstream neighbor node determines whether IGP has converged on the failure of the adjacency node (e.g., whether there is a FIB entry to the adjacency node). In an embodiment, when there is a FIB entry to the adjacency node, the upstream neighbor node, at step 922, determines that IGP has not converged on the failure of the adjacency node and sends the packet to SID-R without going through the failed node. When the upstream neighbor node determines that IGP has converged on the failure of the node, the upstream neighbor node, at step 924, sends the packet along the shortest path to SID-R according to the FIB entry for SID-R.

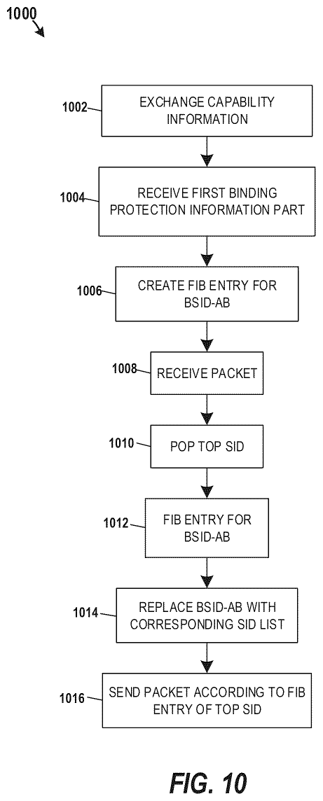

FIG. 10 is a flowchart illustrating a method 1000 for providing SR binding protection according to an embodiment of the present disclosure. In an embodiment, the method 1000 is implemented by an alternate binding node of a binding node on an SR path. In an embodiment, at step 1002, the alternate binding node exchanges capability information with a controller informing the controller that the alternate binding node supports SR binding protection as described above. In some embodiments, step 1002 is not performed. At step 1004, the alternate binding node receives a first binding protection information part for the binding node from the controller. In an embodiment, the first binding protection information part includes a BSID of the alternate border node (BSID-aB) and a corresponding SID list (SID-list 2). SID-list 2 is associated with BSID-aB. SID-list 2 corresponds to SID-list 1, which is associated with a BSID of the binding node (BSID-B). As described above, in an embodiment, the correspondence between SID-list 1 and SID-list 2 is based on whether the first SID in SID-list 1 is an adjacency SID or a node SID. In an embodiment, when the first SID in SID-list 1 is an adjacency SID, the first SID in SID-list 1 is replaced with the node SID of the remote node indicated in the adjacency SID to obtain SID-list 2. In an embodiment, when the first SID in SID-list 1 is a node SID, SID-list2 is the same as SID-list 1. At step 1006, the alternate binding node creates a FIB entry for BSID-aB that instructs the alternate binding node to replace BSID-aB in a packet with SID-list 2. In an embodiment, when SIDs in SID-list 2 are SRv6 SIDs, the alternate binding node pops/removes BSID-aB from the packet and uses H.Encaps to push/prepend SID-list 2 to the packet.

At step 1008, the alternate binding node receives a packet with a top SID of a node SID of the alternate binding node (SID-aB). The alternate binding node, at step 1010, pops the top SID to remove its node SID (SID-aB) from the segment list. The BSID of the alternate binding node (BSID-aB) is now the top SID. At step 1012, the alternate binding node determines the FIB entry of BSID-aB, which instructs the alternate binding node to replace BSID-aB in the packet with a corresponding SID list (SID-list 2). The alternate binding node, at step 1014, replaces BSID-aB in the packet with SID-list 2. At step 1016, the alternate binding node sends the packet according to the FIB entry of the top SID, which is the first SID in SID-list 2.

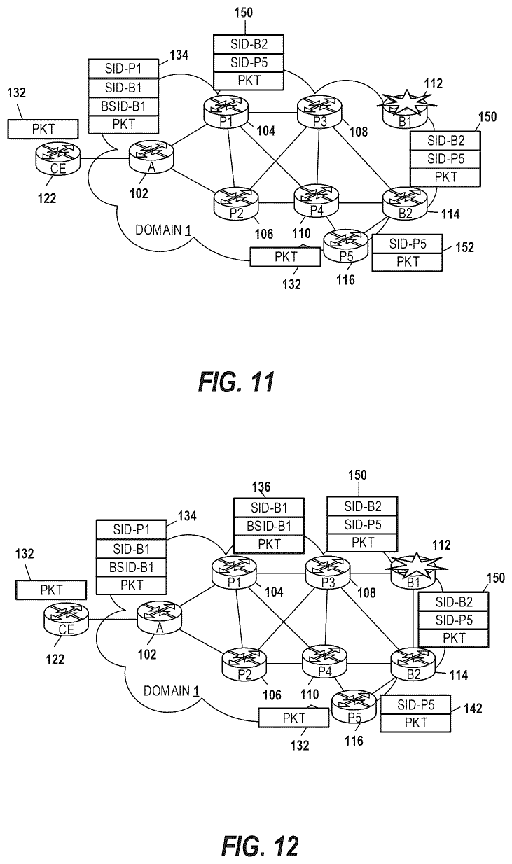

FIG. 11 is a diagram illustrating SR binding protection performed by an upstream endpoint node in accordance with an embodiment. In particular, FIG. 11 illustrates SR binding protection of a packet of SR path 1 illustrated in FIG. 1. As described in FIG. 1, node B1 112 is a binding node associated with SID-list <SID-B2, SID-B5> in SR path 1 (A→P1→B1→BSID-B1 (B2→P5)). As performed in FIGS. 1 and 11, when node A 102 receives a packet 132, node A 102 prepends segment list <SID-P1, SID-B1, BSID-B1> to the packet 132 to obtain packet 134 for routing the packet along SR path 1. Node A 102 then sends the packet to node P1 104 according to the FIB entry for SID-P1. When node P1 104 receives the packet 134, node P1 104 reads the top SID in the segment list of the packet 134. Because the top SID in the segment list in the packet 134 is the SID of node P1 104, node P1 104 pops its node SID (SID-P1) from the top of the segment list in packet 134. Node P1 then reads the top SID of the segment list, which is SID-B1. In contrast to FIG. 1, in FIG. 11, when node P1 104 queries the FIB table for the FIB entry of SID-B1, node P1 104 determines that there is no FIB entry of SID-B1. This means that node B1 112 has failed and IGP has converged on the failure because the FIB table has been updated to remove the FIB entry of SID-B1.

As described above, because node P1 104 is the closest upstream endpoint node to the binding node B1 112 on an SR path 1, node P1 104 received second binding protection information part from the controller and created a FIB entry for BSID-B1 of the binding node B1 112. When there is no FIB entry for SID-B, the upstream endpoint node, node P1 104 determines whether the SID following the top SID (i.e., SID after SID-B1) is a binding SID of the binding node (i.e., BSID-B1). When BSID-B1 follows SID-B1 in the segment list of the packet, node P1 104 pops the top SID to remove SID-B1 so that BSID-B1 becomes the top SID. According to the created FIB entry for BSID-B1 of the binding node B1 112, node P1 104 replaces BSID-B1 in the segment list with the backup SID list (SID-list 3), which is <SID-B2, SID-B5> to obtain packet 150. In an embodiment, when SIDs in SID-list 3 are SRv6 SIDs, node P1 104 pops/removes BSID-B1 from the packet and uses H.Encaps to push/prepend SID-list 3 to the packet. As described above, when the SR path is in one domain, the backup SID list is the same as the SID list associated with the binding SID of the binding node. Node P1 104 then sends the packet 150 to SID-B2 along the shortest path based on the FIB entry for SID-B2. When node B2 114 receives the packet 150, node B2 114 pops its SID from the top SID to obtain packet 152. Node B2 114 sends the packet 152 according to FIB entry for SID-P5. When node P5 116 receives the packet 152, node P5 116 pops its node SID (SID-P5) from the top SID in packet 152 to obtain the original packet 132 without any prepended SIDs.

FIG. 12 is a diagram illustrating SR binding protection performed by an upstream neighbor node in accordance with an embodiment. Similar to FIG. 11, FIG. 12 illustrates SR binding protection of a packet of SR path 1 illustrated in FIG. 1. In contrast to FIG. 11, in this example, node B1 112 has failed, but IGP has not converged on the failure (i.e., meaning that there is a FIB entry for SID-B1). In this case, when node P1 104 receives the packet 134 and after popping the top SID to remove its node SID (SID-P1), node P1 reads the top SID, which is SID-B1, and sends the packet 136 to node P3 108 according to the FIB entry for SID-B1. In the depicted embodiment, because node P3 108 is an upstream neighbor node of binding node B1 112 on an SR path 1, node P3 108 can detect the failure of node B1 112 (e.g., using BFD) even though there is a FIB entry for SID-B1 because IGP has not converged on the failure of node B1 112. Node P3 108 determines whether the SID below the top SID is a binding SID of the node (i.e., BSID-B1), and if so, pops the top SID to remove SID-B1. Node P3 108 as the upstream neighbor node to the binding node B1 112 on an SR path 1, previously received second binding protection information part from the controller and created a FIB entry for BSID-B1 of the binding node B1 112, which instructs node P3 108 to replace BSID-B1 in the segment list with the backup SID list (SID-list 3), which is <SID-B2, SID-B5> to obtain packet 150. In an embodiment, when SIDs in the segment list are SRv6 SIDs, node P3 108 pops BSID-B1 from the packet 136 and uses H.Encaps to push/prepend the SID list to the packet 136 to obtain a packet 150. In an embodiment, because IGP has not converged on the failure, node P3 108 then sends the packet 150 to SID-B2 without going through the failed node (e.g., using TI-LFA). When node B2 114 receives the packet 150, node B2 114 pops its SID from the top SID to obtain packet 142. Node B2 114 sends the packet 142 according to FIB entry for SID-P5. When node P5 116 receives the packet 142, node P5 116 pops its node SID (SID-P5) from the top SID in packet 142 to obtain the original packet 132 without any prepended SIDs.

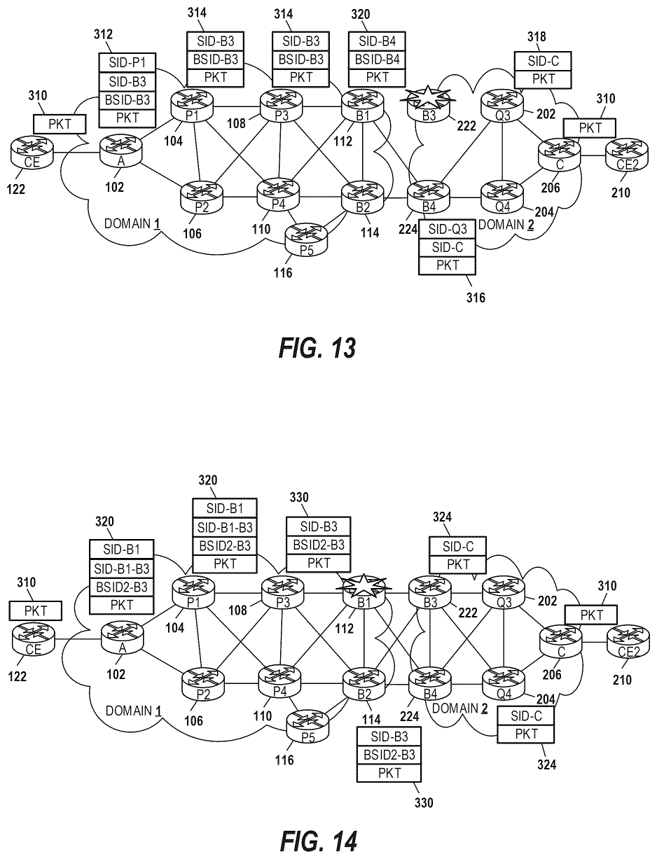

FIG. 13 is a diagram illustrating SR binding protection performed by an upstream neighbor node in accordance with an embodiment. FIG. 13 illustrates SR binding protection of a packet of SR path 3 (A→P1→B3→BSID-B3 (Q3→C)) illustrated in FIG. 3. As described in FIG. 3, node A 102 prepends segment list <SID-P1, SID-B3, BSID-B3> to the packet 310 to obtain a packet 312 and sends the packet 312 according to the FIB entry for SID-P1. In an embodiment, when SIDs for the segment list are SRv6 SIDs, node A 102 uses H.Encaps to push/prepend the segment list to the packet. When node P1 104 receives the packet 312, node P1 104 pops the top SID to remove its node SID to obtain a packet 314 and sends the packet 314 according to the FIB entry for SID-B3, which received by node P3 108. Node P3 108 sends the packet 314 according to the FIB entry for SID-B3, which is received by node B1 112. In this example, node B1 112 as the upstream neighbor node of node B3 222 detects the failure of node B3 222 (either before IGP convergence (e.g., using BFD) or after IGP convergence (e.g., no FIB entry for SID-B3). In an embodiment, to determine that the node B3 222 is a binding node on the SR path, the upstream neighbor node determines whether the SID below the top SID is a binding SID of node B3 222, and if so, the node B1 112 pops the top SID to remove SID-B3. As described above, node B1 112 previously received second binding protection information part from the controller and created a FIB entry for BSID-B3 of the binding node B3 222, which instructs node B1 112 to replace BSID-B3 in the segment list with the backup SID list (SID-list 3) to obtain packet 320. In an embodiment, when SIDs in the backup SID list (SID-list 3) are SRv6 SIDs, node B1 112 pops BSID-B3 from the packet and uses H.Encaps to push/prepend the backup SID list (SID-list 3) to the packet. SID-list 3 for an SR path crossing two domains, as described above, is <SID-B4, BSID-B4> containing the SID of the alternate binding node and a BSID of the alternate binding node. If node B1 112 detected the failure of node B3 222 before IGP convergence, node B1 112 sends packet 320 according to its FIB entry for SID-B4 without going through the failed node B3 222. If node B1 112 detected the failure of node B3 222 after IGP convergence, node B1 112 sends packet 320 according to its FIB entry for SID-B4 along the shortest path to B4. As previously described, node B4 224 as the alternate binding node previously received the first binding protection information part for node B3 222 from the controller and created a FIB entry for BSID-B4. When node B4 224 receives the packet 320, node B4 224 pops the top SID to remove its node SID. Node B4 224 then replaces BSID-B4 in the packet with a SID list (SID-list 2), which was included in the first binding protection information part. As described above, because first SID in SID-list 1 associated with BSID-B3<SID-Q3, SID-C> is a node SID, SID-list 2 is the same as SID-list 1. Therefore, node B4 224 replaces BSID-B4 in the packet with <SID-Q3, SID-C> to obtain packet 316. Node B4 224 sends the packet 316 according to the FIB entry for SID-Q3. When node Q3 202 receives the packet 316, node Q3 202 pops its node SID from the top of the segment list in packet 316 to obtain a packet 318. Node Q3 202 sends the packet 318 according to the FIB entry for SID-C. When node C 206 receives the packet 318, node C 206 pops its node SID from the top of the segment list in packet 318 to obtain the original packet 310. In an embodiment, node C 206 sends the packet 310 to CE 210. Thus, as shown above, the disclosed embodiments provide SR protection for a binding node failure in an SR path.

FIG. 14 is a diagram illustrating SR adjacency protection performed by an upstream neighbor node in accordance with an embodiment. FIG. 14 illustrates SR adjacency protection of a packet of SR path 4 (A→B1→B1-B3→BSID2-B3 (B3-Q4→C)) illustrated in FIG. 4. As described above, node B1 112 in FIG. 14 is an adjacency node because SID-B1-B3 is an adjacency SID of node B1 112 in the SR path that is used for crossing the two domains or the next hop of node B1 112 is in the second domain. In the depicted embodiment, assume that node B1 112 has failed and IGP has not converged on the failure. Like FIG. 4, in FIG. 14, node A 102 prepends segment list <SID-B1, SID-B1-B3, BSID2-B3> to the packet 310 to obtain a packet 320 and sends the packet 320 according to the FIB entry for SID-B1. When node P1 104 receives the packet 320, node P1 104 sends the packet 320 according to its FIB entry for SID-B1. When node P3 108 receives the packet 320, node P3 108 as the upstream neighbor node of node B1 112 detects the failure of node B1 112 (e.g., using BFD). As described above, node P3 108 previously received adjacency protection information from the controller and created a FIB entry for SID-B1-B3 of the adjacency node, which instructs node P3 108 to replace SID-B1-B3 in the segment list with SID-B3. Node P3 108 pops the top SID to remove SID-B1 and then per its FIB entry for SID-B1-B3, replaces SID-B1-B3 in the segment list with SID-B3 to obtain packet 330. In an embodiment, when SIDs in the segment list are SRv6 SIDs, node P3 108 pops SID-B1-B3 from the packet 320 and uses H. Encaps to push/prepend SID-B3 to the packet 320 to obtain packet 330. In this example, IGP has not converged on the failure of the adjacency node and node P3 108 sends the packet 330 to SID-R according to its FIB entry for SID-R, which is SID-B3 in this example, without going through the node B1 112. For instance, in FIG. 14, node P3 108 sends the packet 330 to node B2 114. When node B2 114 receives the packet 330, node B2 114 sends the packet 330 to the top SID (SID-B3) according to its FIB entry for SID-B3. When node B3 222 receives the packet 330, node B3 222 pops its node SID from the top SID. BSID2-B3 is now the top SID. Like in FIG. 4, BSID2-B3 is associated with SID list: <SID-B3-Q4, SID-C>. Node B3 222 replaces BSID2-B3 in the segment list with SID list: <SID-B3-Q4, SID-C>. In an embodiment, when SIDs in the SID list are SRv6 SIDs, node B3 222 pops BSID2-B3 from the packet and uses H.Encaps to push/prepend the SID list to the packet. As described above, SID-B3-Q4 is an adjacency SID that specifies a strict single-hop for carrying packets over a specific link from node B3 222 to node Q4 204. Prior to transmitting the packet over the specific link from node B3 222 to node Q4 204, node B3 222 pops SID-B3-Q4 from the segment list to obtain a packet 324. When node Q4 204 receives the packet 324, node Q4 204 reads the top SID in the packet 324, which is SID-C. Node Q4 204 sends the packet 324 according to its FIB entry for SID-C. When node C 206 receives the packet 324, node C 206 pops its node SID from the top of the segment list in packet 324 to obtain the original packet 310. In an embodiment, node C 206 sends the packet 310 to CE 210. Thus, as shown above, the disclosed embodiments provide SR adjacency protection for an adjacency node failure in an SR path.

FIG. 15 illustrates a BAP CAPABILITY sub-TLV 1500 according to an embodiment of the present disclosure. As described above, in an embodiment, a node and the controller exchange capability of distributing binding and adjacency protection information using the BAP CAPABILITY sub-TLV 1500 in a PCEP OPEN message. In an embodiment, the BAP CAPABILITY sub-TLV 1500 includes a Type field 1502, a Length field 1504, a Reserved field 1506, and a Flags field 1508. The Type field 1502 includes a TBD type value (e.g., TBD2) indicating that the TLV is a BAP CAPABILITY sub-TLV type. The Length field 1504 indicates the length in bytes of the BAP CAPABILITY sub-TLV 1500 following the Length field 1504 (e.g., Length field 1504 contains the value 4 indicating that the BAP CAPABILITY sub-TLV 1500 includes 4 bytes after the Length field 1504). The Reserved field 1506 is a 2-byte field that is reserved for future use. The Flags field 1508 is a 2-byte field that may be used to indicate one or more flags such as a first flag (B flag) indicating that a PCC and/or PCE supports binding protection, a second flag (A flag) indicating that a PCC and/or PCE supports adjacency protection, a third flag (V flag) indicating that a PCC and/or PCE supports SRv6 SIDs, and a fourth flag (M flag) indicating that a PCC and/or PCE supports SR-MPLS SIDs as described in the present disclosure. In an embodiment, the first flag must be set to 1 by both a PCC and a PCE for the binding protection information on a PCEP session. In an embodiment, the second flag must be set to 1 by both a PCC and a PCE for the adjacency protection information on a PCEP session. In an embodiment, both the first flag and the second flag must be set to 1 by both a PCC and a PCE for the binding and adjacency protection information on a PCEP session. In an embodiment, the third flag must be set to 1 by both a PCC and a PCE for SRv6 SIDs in the binding and/or adjacency protection information on a PCEP session. In an embodiment, the fourth flag must be set to 1 by both a PCC and a PCE for SR-MPLS SIDs in the binding and/or adjacency protection information on a PCEP session. In an embodiment, both the third flag and the fourth flag must be set to 1 by both a PCC and a PCE for SR-MPLS SIDs and SRv6 SIDs in the binding and/or adjacency protection information on a PCEP session. In an embodiment, all unassigned bits MUST set to 0 at transmission and ignored at receipt.

FIG. 16 illustrates a PATH-SETUP-TYPE-CAPABILITY TLV 1600 according to an embodiment of the present disclosure. In an embodiment, the PATH-SETUP-TYPE-CAPABILITY TLV 1600 includes the BAP CAPABILITY sub-TLV 1500 in FIG. 15 in a PCEP OPEN message for exchanging capability information between a node and the controller. In an embodiment, the PATH-SETUP-TYPE-CAPABILITY TLV 1600 is included in an OPEN object in an Open message by a PCEP speaker (e.g., a PCC or a PCE transmitting the Open message) to indicate the PCEP speaker supports PCEP extensions for the PCECC (i.e., traffic engineering path is set up using PCECC mode). The PATH-SETUP-TYPE-CAPABILITY TLV 1600 includes a Type field 1602, a Length field 1604, a Reserved field 1606, a number of PST (Num of PSTs) field 1608, one or more PST fields indicated by the value in the Num of PSTs field 1608 (e.g., PST #1 field 1610, PST #2 field 1612, PST #N field 1614, and PST field 1616), a Padding field 1618, and an optional sub-TLVs field 1620. The Type field 1602 is 34, which is assigned to a PATH-SETUP-TYPE-CAPABILITY TLV. The Length field 1604 indicates a total length in bytes of the remainder of the PATH-SETUP-TYPE-CAPABILITY TLV 1600 (i.e., the length of the PATH-SETUP-TYPE-CAPABILITY TLV 1600 following Length field 1604). The Reserved field 1606 is reserved for future use and is set to 0 by the sender and ignored by the receiver. The Num of PSTs field 1608 indicates the number of PSTs in the PATH-SETUP-TYPE-CAPABILITY TLV following the Num of PSTs field 1608, excluding the Padding field 1618. PST #1 field 1610, PST #2 field 1612, PST #N field 1614, and PST field 1616 indicate the PSTs that the PCEP speaker supports. Each PST field (e.g., PST #1 field 1610) is a single byte in length. In an embodiment, PST field 1616 includes a TBD value (e.g., TBD1) that indicates the PCEP speaker supports distributing binding and/or adjacency protection information in an Open message. The Padding field 1618 includes Os. The optional sub-TLVs field 1620 includes one or more sub-TLVs associated with the supported PSTs. For example, in an embodiment, the optional sub-TLVs field 1620 includes the BAP CAPABILITY sub-TLV 1500 in FIG. 15.

FIG. 17 illustrates PCECC-CAPABILITY sub-TLV 1700 according to an embodiment of the present disclosure. In an embodiment, a PCC on a neighbor node and a PCE exchange capability of distributing binding and adjacency protection information using PCECC-CAPABILITY sub-TLV 1700. In an embodiment, the PCECC-CAPABILITY sub-TLV 1700 is an optional TLV in the PATH-SETUP-TYPE-CAPABILITY TLV 1600 of FIG. 16 in an OPEN object in an Open message. The PCECC-CAPABILITY sub-TLV 1700 includes a Type field 1702, a Length field 1704, and a Flags field 1706. The Type field 1702 includes a type value of 1. The Length field 1704 indicates the length in bytes of the PCECC-CAPABILITY sub-TLV 1700 following the Length field 1704 (e.g., Length field 1704 contains the value 4 indicating that the PCECC-CAPABILITY sub-TLV 1700 includes 4 bytes after the Length field 1704). The Flags field 1706 is a 4-byte field that may be used to indicate one or more flags such as a flag. For example, in the depicted embodiment, Flags field 1706 includes an A flag bit field 1708, a B flag bit field 1710 and an L flag bit field 1712. In an embodiment, the A flag bit field 1708 and B flag bit field 1710 each is set to 1 by a PCEP speaker (e.g., a PCC or a PCE transmitting the Open message) to indicate that the PCEP speaker supports and is willing to handle the PCECC based central controller instructions for binding and adjacency protection respectively. In an embodiment, the A flag bit field 1708 must be set to 1 by both a PCC and a PCE for the PCECC adjacency protection instruction download/report on a PCEP session. In an embodiment, the B flag bit field 1710 must be set to 1 by both a PCC and a PCE for the PCECC binding protection instruction download/report on a PCEP session. In an embodiment, both the A flag bit field 1708 and the B flag bit field 1710 must be set to 1 by both a PCC and a PCE for the PCECC binding and adjacency protection instruction download/report on a PCEP session. The L flag bit field 1712 is set to 1 to indicate that the PCEP speaker supports and is willing to handle the PCEC-based central controller instructions for label download. In an embodiment, the L flag bit field 1712 is set to 1 by both a PCC and a PCE for the PCECC label download/report on a PCEP session. In an embodiment, all unassigned bits is set to 0 at transmission and ignored at receipt.

FIG. 18 illustrates a PATH-SETUP-TYPE TLV 1800 according to an embodiment of the present disclosure. In an embodiment, the PATH-SETUP-TYPE TLV 1800 is included in a Request Parameters (RP) object or Stateful PCE Request Parameters (SRP) object in a PCEP message such as a PCUpd message for transmitting binding and/or adjacency protection information. The PATH-SETUP-TYPE TLV 1800 enables a PCEP speaker to specify which setup method should be used for a given LSP. In an embodiment, the PATH-SETUP-TYPE TLV 1800 includes a Type field 1802, a Length field 1804, a Reserved field 1806, and a PST field 1808. In an embodiment, the Type field 1802 is set to 28. The Length field 1804 contains the value 4 indicating that the PATH-SETUP-TYPE TLV 1800 includes 4 bytes after the Length field 1804. The Reserved field 1806 is reserved for future use and is set to 0 by the sender and ignored by the receiver. The PST field 1808 indicates a TBD value (e.g., PST=TBD1) indicating the PATH-SETUP-TYPE TLV is for binding and/or adjacency protection information for a node for protecting binding or adjacency of the node.

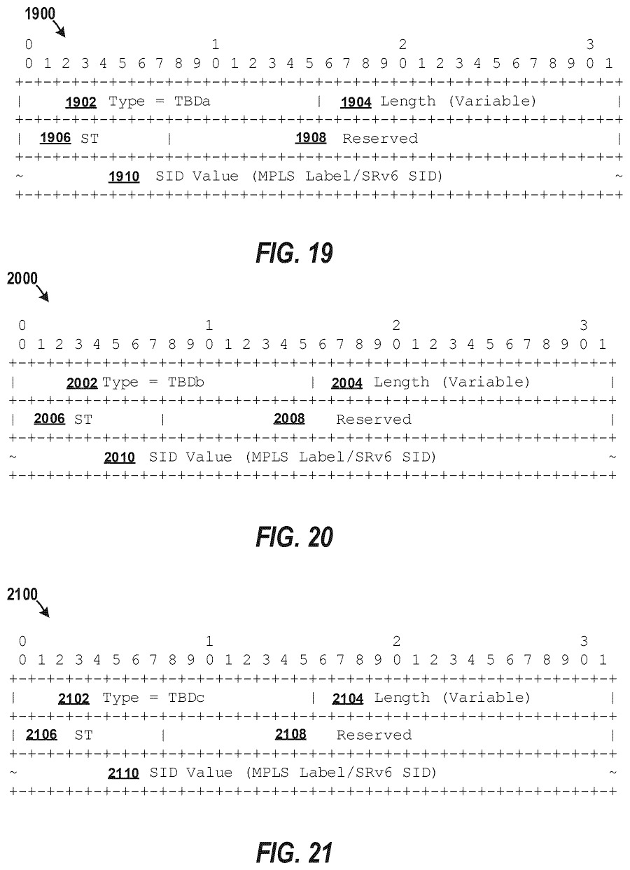

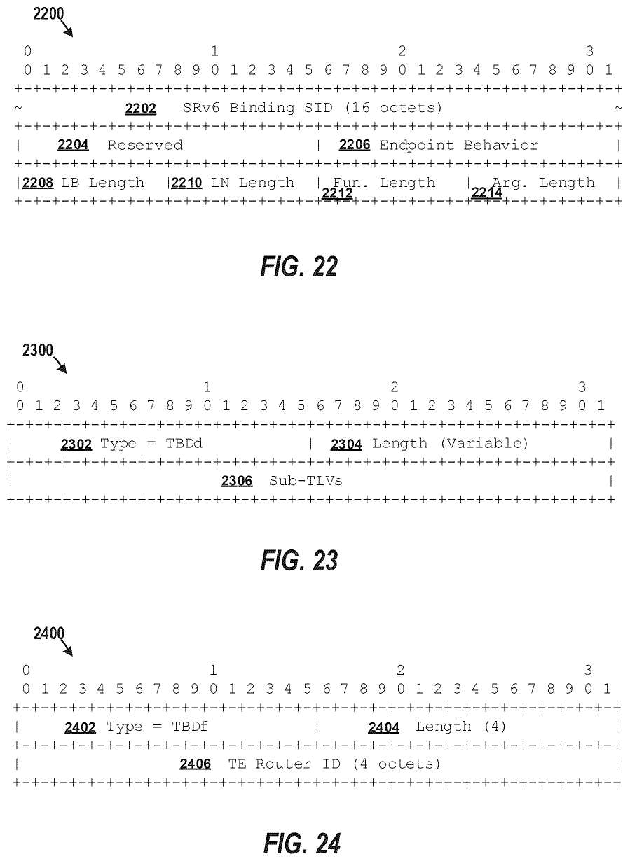

FIG. 19 illustrates a BSID TLV 1900 according to an embodiment of the present disclosure. In an embodiment, the BSID TLV 1900 is included in a RP object or SRP object in a PCEP message such as a PCUpd message for transmitting binding and/or adjacency protection information. In an embodiment, the BSID TLV 1900 includes a Type field 1902, a Length field 1904, a SID Type (ST) field 1906, a Reserved field 1908, and a SID value field 1910. In an embodiment, the Type field 1902 specifies a TBD type value assigned to a BSID TLV type (e.g., TBDa). The Length field 1904 contains a (variable) value indicating the number of bytes after the Length field 1904 in the BSID TLV 1900. The ST field 1906 is a 1-byte field that identifies the type of SID in BSID TLV 1900. In an embodiment, the ST field 1906 is set to a value of 1 to indicate that the SID value in the SID value field 1910 is a 20-bit multiprotocol label switching (MPLS) label. In this embodiment, the Length field 1904 is set to 7 and the BSID TLV 1900 is padded to 4-bytes alignment. In an embodiment, the ST field 1906 is set to a value of 2 to indicate that the SID value in the SID value field 1910 is a 32-bit MPLS label stack entry. In an embodiment, the ST field 1906 is set to a value of 3 to indicate that the SID value in the SID value field 1910 is a 24-octet field containing a SRv6 SID with behavior and structure. An example format of a SRv6 SID with behavior and structure format is illustrated in FIG. 22. The Reserved field 1908 is reserved for future use and is set to 0 by the sender and ignored by the receiver. The SID value field 1910 specifies a BSID.

FIG. 20 illustrates an adjacency SID TLV 2000 according to an embodiment of the present disclosure. In an embodiment, the adjacency SID TLV 2000 is included in a RP object or SRP object in a PCEP message such as a PCUpd message for transmitting binding and/or adjacency protection information. In an embodiment, the adjacency SID TLV 2000 includes a Type field 2002, a Length field 2004, a ST field 2006, a Reserved field 2008, and a SID value field 2010. In an embodiment, the Type field 2002 specifies a TBD type value assigned to an adjacency SID TLV type (e.g., TBDb). The Length field 2004 contains a (variable) value indicating the number bytes after the Length field 2004 in the adjacency SID TLV 2000. The ST field 2006 is a 1-byte field that identifies the type of SID in the adjacency SID TLV 2000. In an embodiment, the ST field 2006 is set to a value of 1 to indicate that the SID value in the SID value field 2010 is a 20-bit MPLS label. In this embodiment, the Length field 2004 is set to 7 and the adjacency SID TLV 2000 is padded to 4-bytes alignment. In an embodiment, the ST field 2006 is set to a value of 2 to indicate that the SID value in the SID value field 2010 is a 32-bit MPLS label stack entry. In an embodiment, the ST field 2006 is set to a value of 3 to indicate that the SID value in the SID value field 2010 is a 24-octet field containing a SRv6 SID with corresponding behavior and structure. The Reserved field 2008 is reserved for future use and is set to 0 by the sender and ignored by the receiver. The SID value field 2010 specifies an adjacency SID.

FIG. 21 illustrates a node SID TLV 2100 according to an embodiment of the present disclosure. In an embodiment, the node SID TLV 2100 is included in a RP object or SRP object in a PCEP message such as a PCUpd message for transmitting binding and/or adjacency protection information. In an embodiment, the node SID TLV 2100 includes a Type field 2102, a Length field 2104, a ST field 2106, a Reserved field 2108, and a SID value field 2110. In an embodiment, the Type field 2102 specifies a TBD type value assigned to a node SID TLV type (e.g., TBDc). The Length field 2104 contains a (variable) value indicating the number bytes after the Length field 2104 in the node SID TLV 2100. The ST field 2106 is a 1-byte field that identifies the type of SID in the node SID TLV 2100. In an embodiment, the ST field 2106 is set to a value of 1 to indicate that the SID value in the SID value field 2110 is a 20-bit MPLS label. In this embodiment, the Length field 2104 is set to 7 and the node SID TLV 2100 is padded to 4-bytes alignment. In an embodiment, the ST field 2106 is set to a value of 2 to indicate that the SID value in the SID value field 2110 is a 32-bit MPLS label stack entry. In an embodiment, the ST field 2106 is set to a value of 3 to indicate that the SID value in the SID value field 2110 is a 24-octet field containing a SRv6 SID with behavior and structure. The Reserved field 2108 is reserved for future use and is set to 0 by the sender and ignored by the receiver. The SID value field 2110 specifies a node SID.

FIG. 22 illustrates a SRv6 SID with behavior and structure format (SRv6 SID+B/S) 2200 according to an embodiment of the present disclosure. In an embodiment, the SRv6 SID+B/S 2200 is included in the SID value field 1910 of the BSID TLV 1900 in FIG. 19, the SID value field 2010 of the adjacency SID TLV 2000 in FIG. 20, or the SID value field 2110 of the node SID TLV 2000 in FIG. 21 for specifying an SRv6 SID with behavior and structure. In an embodiment, the SRv6 SID+B/S 2200 includes SRv6 Binding SID field 2202, a Reserved field 2204, an Endpoint Behavior field 2206, a Locator Block (LB) Length field 2208, a Locator Node (LN) Length field 2210, a Function (Fun.) Length field 2212, and an Argument (Arg.) Length field 2214. In an embodiment, the SRv6 Binding SID field 2202 is a 16 octets/byte field that contains a 128-bit Internet Protocol (IP) version 6 (IPv6) address of a node. The Reserved field 2204 is a 2-octet field that is reserved for future use and is set to 0 by the sender and ignored by the receiver. The Endpoint Behavior field 2206 is a 2-octet field that encodes an SRv6 endpoint behavior codepoint value that is associated with the SRv6 SID specified in the SRv6 Binding SID field 2202. SRv6 endpoint behavior codepoint values are assigned by the Internet Assigned Numbers Authority (IANA) registry and defined in section 10.2 of RFC 8986 titled “Segment Routing over IPv6 (SRv6) Network Programming” published on February 2021. The LB Length field 2208 is a 1 octet field that indicates a length of the SRv6 SID locator block in bits. The LN Length field 2210 is a 1 octet field that indicates a length of the SRv6 SID locator node in bits. The Fun. Length field 2212 is a I octet field that indicates a length of an SRv6 SID function in bits. The Arg. Length field 2214 is a 1 octet field that indicates a length of an SRv6 SID argument in bits.

FIG. 23 illustrates a SID-List TLV 2300 according to an embodiment of the present disclosure. In an embodiment, the SID-List TLV 2300 may be used to specify a SID list in an RP object or SRP object of a PCEP message such as a PCUpd message. In an embodiment, the SID-List TLV 2300 includes a Type field 2302, a Length field 2304, and a Sub-TLVs field 2306. The Type field 2302 specifies a TBD type value assigned to a SID-List TLV type (e.g., TBDd). The Length field 2304 contains a (variable) value indicating the number bytes after the Length field 2304 in the SID-List TLV 2300. The Sub-TLVs field 2306 specifies a number of Sub-TLVs in the SID-List TLV 2300. Each Sub-TLV is a node SID TLV (e.g., node SID TLV 2100 in FIG. 21), an adjacency SID TLV (e.g., adjacency SID TLV 2000 in FIG. 20), or a BSID TLV (e.g., BSID TLV 1900 in FIG. 19).

FIG. 24 illustrates a TE Router ID TLV 2400 according to an embodiment of the present disclosure. In an embodiment, the TE Router ID TLV 2400 is a Node ID TLV that is used to specify an ID of a node in an RP object or SRP object of a PCUpd message. The TE Router ID TLV 2400 includes a Type field 2402, a Length field 2404, and a TE Router ID field 2406. The Type field 2402 specifies a TBD type value assigned to a TE Router ID TLV type (e.g., TBDf). The Length field 2404 contains a value 4 indicating the number bytes after the Length field 2404 in the TE Router ID TLV 2400. The TE Router ID field 2406 is a 4-octet field that specifies a TE router ID.

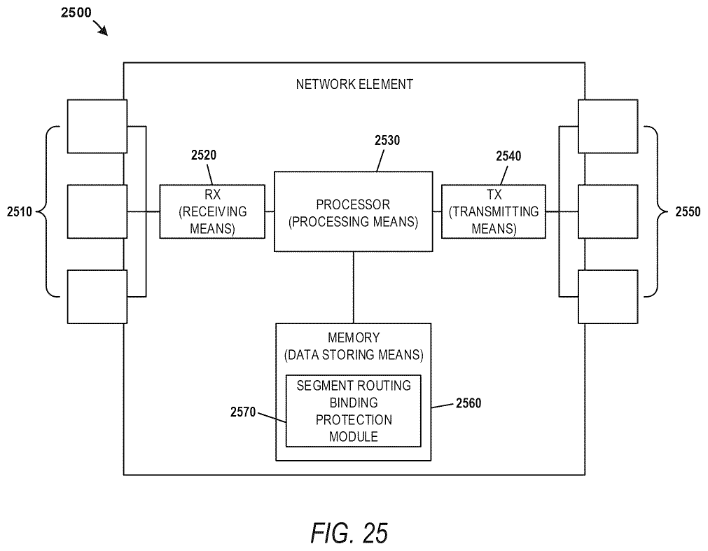

FIG. 25 is a diagram illustrating a network device 2500 according to an embodiment of the present disclosure. The network device 2500 can implement any type of network node in the present disclosure such as, but not limited to, a network node, a controller, a border router. The network device 2500 includes receiver units (RX) 2520 or receiving means for receiving data via ingress ports 2510. The network device 2500 also includes transmitter units (TX) 2540 or transmitting means for transmitting via data egress ports 2550.

The network device 2500 includes a memory 2560 or data storing means for storing the instructions and various data. The memory 2560 can be any type of or combination of memory components capable of storing data and/or instructions. For example, the memory 2560 can include volatile and/or non-volatile memory such as read-only memory (ROM), random access memory (RAM), ternary content-addressable memory (TCAM), and/or static random-access memory (SRAM). The memory 2560 can also include one or more disks, tape drives, and solid-state drives. In some embodiments, the memory 2560 can be used as an over-flow data storage device to store programs when such programs are selected for execution, and to store instructions and data that are read during program execution.

The network device 2500 has one or more processor 2530 or other processing means (e.g., central processing unit (CPU)) to process instructions. The processor 2530 may be implemented as one or more CPU chips, cores (e.g., as a multi-core processor), field-programmable gate arrays (FPGAs), application specific integrated circuits (ASICs), and digital signal processors (DSPs). The processor 2530 is communicatively coupled via a system bus with the ingress ports 2510, RX 2520, TX 2540, egress ports 2550, and memory 2560. The processor 2530 can be configured to execute instructions stored in the memory 2560. Thus, the processor 2530 provides a means for performing any computational, comparison, determination, initiation, configuration, or any other action corresponding to the claims when the appropriate instruction is executed by the processor. In some embodiments, the memory 2560 can be memory that is integrated with the processor 2530.

In one embodiment, the memory 2560 stores a SR Binding Protection Module 2570. The SR Binding Protection Module 2570 includes data and executable instructions for implementing the disclosed embodiments. For instance, the SR Binding Protection Module 2570 can include instructions for implementing one or more of the methods described in FIG. 5 through FIG. 10 described herein. In an embodiment, the SR Binding Protection Module 2570 includes instructions implementing an integrated procedure on a node that forwards a packet to be transported by an SR path (e.g., a border node or an internal node). An example pseudocode of an integrated procedure corresponding to methods described in the present disclosure is shown below. The text preceded by a “//” in the pseudocode indicate non-executable comments that help explain the pseudocode. The “Packet” in the pseudocode refers to the packet received by node X on the SR path.

```
IF (X detects N's failure) {//X is neighbor of N, before convergence
  Pops top SID from Packet; // pops SID-N or SID-X-N
  IF (top SID in Packet is Binding SID (BSID) of N) {
      Replace BSID in Packet with SID list;
  }
  Sends Packet without going N using TI-LFA for top SID in Packet;
} ELSE {//Normal or (N failed and after convergence on failure)
  IF (no FIB entry for top SID in Packet) {//N failed, after converges
    Pops top SID from Packet;//pops SID-N or SID-X-N
    IF (top SID in Packet is Binding SID (BSID) of N) {
      Replace BSID in Packet with SID list;
    }
  } //Normal case: there is FIB entry for top SID, N works
  Sends Packet using FIB entry for top SID in Packet;
}
IF (the primary next hop interface to the top SID in Packet failed) {// X as PLR neighbor of failed
N
  IF (the top SID in Packet is Adjacency SID of N) {
    Replace the top SID with node SID of remote node;}
  ELSE IF (the top SID in Packet is node SID of N) {
    Pops the top SID from Packet; // pops node SID of failed N
    IF (the top SID in Packet is Binding SID) {
      Executes the action indicated by the FIB entry for Binding SID;}
  }
  Sends Packet to node having the top SID in Packet without going through failed N;
} ELSE {// X as upstream node of failed N
  IF (the top SID in Packet is the node SID of node X) {//top SID is node SID of node X
    Pops (i.e., removes) the top SID from Packet;}
  IF (there is no FIB entry for the top SID in Packet) {// IGP converges on N's failure
    Pops (i.e., removes) the top SID from Packet; // pops node SID of failed N
    IF (the top SID in Packet is a node SID of node Nx) {// next SID is node SID
      Sends Packet using the FIB entry for the top SID in Packet (i.e., node SID of Nx);
    } ELSE IF (the top SID in Packet is an adjacency SID of N) {// next SID is adj SID
      Obtains remote node R of the adjacency from the adjacency SID;
      Replaces the adjacency SID in Packet with the node SID of R;
      Sends Packet using the FIB entry for the top SID in Packet (i.e., node SID of R);
    } ELSE IF (the top SID in Packet is a Binding SID of N) {// next SID is binding SID
      Executes the action indicated by the FIB entry for Binding SID;
      Send Packet using the FIB entry for the top SID in Packet.
    }
  } ELSE {// Normal case, N works well and there is FIB entry for node SID of N
    Sends Packet using the FIB entry for the top SID in Packet (i.e., node SID of N);
  }
}
Action indicated by the FIB entry for Binding SID associated with a SID list:
  IF SIDs in list are in the same domain as X, Replace Binding SID in Packet with SID list.;
  ELSE Push node SID of another border node into Packet;
```

As shown above, the integrated procedure includes instructions for processing a packet when there is no failure and when there is a failure (either at a border node or an internal node) along the SR path. Thus, the inclusion of the SR Binding Protection Module 2570 substantially improves the functionality of the network device 2500.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the disclosure is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

Following the claims below is a document that may be submitted to a standards body and which embodies the present disclosure.

What is claimed is:

1. A method implemented by a controller, the method comprising:
determining binding information of a binding node on a segment routing (SR) path;
determining binding protection information based on the binding information; and
transmitting the binding protection information, wherein the binding protection information supports routing of a packet when the binding node fails.

2. The method of claim 1, further comprising exchanging capability information with nodes on the SR path, the capability information indicating whether the nodes support binding and/or adjacency protection.

3. The method of claim 2, wherein exchanging capability information comprises exchanging a Path Computation Element (PCE) Communication Protocol (PCEP) OPEN message comprising a PATH_SETUP_TYPE_CAPABILITY Type-Length-Value (TLV), the PATH_SETUP_TYPE_CAPABILITY TLV comprising a Path Setup Type (PST) and a BINDING ADJACENCY PROTECTION (BAP) CAPABILITY sub-TLV, and wherein the PST comprises a value indicating a capability of binding and/or adjacency protection.

4. The method of claim 2, wherein exchanging capability information comprises exchanging a PCEP OPEN message comprising a PATH_SETUP_TYPE_CAPABILITY TLV, the PATH_SETUP_TYPE_CAPABILITY TLV comprising a Central Controller (PCECC)-CAPABILITY sub-TLV, and wherein the PCECC-CAPABILITY Sub-TLV comprises a B flag field set to a first value indicating a first capability of binding protection and an A flag field set to a second value indicating a second capability of adjacency protection.

5. The method of claim 1, further comprising determining that the SR path is within a domain, and wherein transmitting the binding protection information comprises:
transmitting a second binding protection information part to an upstream neighbor node of the binding node on the SR path, wherein the second binding protection information part comprises a binding segment identifier (BSID) of the binding node (BSID-B), a backup SID list, and an identifier (ID) of the binding node (ID-B).

6. The method of claim 5, wherein the second binding protection information part further comprises an instruction, wherein the instruction instructs the upstream neighbor node to use the second binding protection information part when the binding node on the SR path fails.

7. The method of claim 1, further comprising transmitting second binding protection information part to a closest upstream endpoint node of the binding node on the SR path when the binding node is a loose hop on the SR path and the closest upstream endpoint node is not a neighbor node of the binding node.

8. The method of claim 1, further comprising determining that the SR path crosses from a first domain to a second domain.

9. The method of claim 8, further comprising determining that one provider operates the first domain and the second domain, and wherein transmitting the binding protection information comprises:
transmitting a second binding protection information part to an upstream neighbor node of the binding node on the SR path, wherein the second binding protection information part comprises a BSID of the binding node (BSID-B), a backup SID list, and an ID of the binding node (ID-B); and
transmitting the second binding protection information part to a closest upstream endpoint node of the binding node on the SR path when the binding node is a loose hop on the SR path and the closest upstream endpoint node is not a neighbor node of the binding node.

10. The method of claim 9, further comprising:
determining an adjacency segment identifier (SID) of a node in the SR path used for crossing the first domain and the second domain or the next hop of the node is in the second domain; and
transmitting adjacency protection information to an upstream neighbor node of the node, wherein the adjacency protection information supports routing of the packet when the node fails.

11. The method of claim 10, further comprising transmitting the adjacency protection information a closest upstream endpoint node of the node when the node is a loose hop on the SR path and the closest upstream endpoint node is not a neighbor node of the node.

12. The method of claim 8, further comprising determining that a first provider operates the first domain and a second provider operates the second domain, and wherein transmitting the binding protection information comprises:
transmitting a first binding protection information part to an alternate binding node, wherein the first binding protection information part comprises a BSID of the alternate binding node (BSID-aB) and a corresponding SID list, the corresponding SID list is obtained from a binding SID list of the binding node based on a first SID in the binding SID list;
transmitting a second binding protection information part to an upstream neighbor node of the binding node on the SR path, wherein the second binding protection information part comprises a BSID of the binding node (BSID-B), a backup SID list, and an ID of the binding node (ID-B); and
transmitting the second binding protection information part to a closest upstream endpoint node of the binding node on the SR path when the binding node is a loose hop on the SR path and the closest upstream endpoint node is not a neighbor node of the binding node.

13. The method of claim 12, wherein the corresponding SID list is the same as the binding SID list when the first SID in the binding SID list is a node SID, and wherein the corresponding SID list is obtained by replacing the first SID in the binding SID list with a node SID of a remote node when the first SID in the binding SID list is an adjacency SID to the remote node.

14. The method of claim 1, wherein the binding information comprises an ID of the binding node, a BSID of the binding node, and a binding SID list associated with the BSID.

15. A method implemented by a node, the method comprising:
receiving binding protection information for a binding node on a segment routing (SR) path, wherein the binding protection information supports routing of a packet when the binding node fails;
creating a first forwarding information base (FIB) entry based on the binding protection information;
receiving a packet; and
executing a first instruction according to the first FIB entry for routing the packet when the binding node fails.

16. The method of claim 15, wherein the node is an upstream neighbor node of the binding node on the SR path, wherein the binding protection information comprises a second binding protection information part, and wherein the second binding protection information part comprises a binding segment identifier (BSID) of the binding node (BSID-B), a backup SID list, and an identifier (ID) of the binding node (ID-B).

17. The method of claim 15, wherein the node is a closest upstream endpoint node of the binding node on the SR path, wherein the binding protection information comprises a second binding protection information part, and wherein the second binding protection information part comprises a binding segment identifier (BSID) of the binding node (BSID-B), a backup SID list, and an identifier (ID) of the binding node (ID-B).

18. The method of claim 15, further comprising:
receiving adjacency protection information for an adjacency node on an SR path, wherein the adjacency protection information supports routing of the packet when the adjacency node fails;
creating a second FIB entry based on the adjacency protection information; and
executing a second instruction according to the second FIB entry for routing the packet when the adjacency node fails.

19. The method of claim 18, wherein the adjacency protection information comprises an adjacency SID of the adjacency node (SID-B-R), a node SID of a remote node of the adjacency SID (SID-R), and an ID of the adjacency node (ID-B), and wherein the second instruction instructs the node to replace the adjacency SID of the adjacency node (SID-B-R) in a segment list of the packet with the node SID of the remote node (SID-R) when the adjacency node fails.

20. The method of claim 15, wherein the node is an alternate binding node of the binding node, wherein the binding protection information comprises a first binding protection information part, wherein the first binding protection information part comprise a BSID of the alternate binding node (BSID-aB) and a corresponding SID list, wherein the corresponding SID list is obtained from a binding SID list of the binding node based on a first SID in the binding SID list, and wherein the first instruction instructs the node to replace the BSID-aB in a segment list of the packet with the corresponding SID list.
